(19) United States
(12) Patent Application Publication
(10) Pub. No.: US 2022/0360699 A1
(43) Pub. Date: Nov. 10, 2022

(54) MACHINE LEARNING BASED PHONE IMAGING SYSTEM AND ANALYSIS METHOD

(71) Applicant: Sensibility Pty Ltd, Tonsley (AU)

(72) Inventors: Krishnapillai ANANDASIVAM, Blackwood (AU); Jarrad Rhys LAW, Sheidow Park (AU)

(73) Assignee: Sensibility Pty Ltd, Tonsley (AU)

(21) Appl. No.: 17/647,691

(22) PCT Filed: Jul. 10, 2020
(86) PCT No.: PCT/AU2020/000067

§ 371 Date: Jan. 11, 2022

(30) Foreign Application Priority Data
Jul. 11, 2019 (AU) 2019902460

(51) Int. Cl. H04N 5/225; G02B 21/36; G06V 10/764

(52) U.S. Cl. CPC H04N 5/22541; H04N 5/2252; G02B 21/362; G06V 10/764

(57) ABSTRACT

A machine learning based imaging system comprises an imaging apparatus for attachment to an imaging sensor of a mobile computing apparatus such as camera of a smartphone. A machine learning (or AI) based analysis system is trained on images captured with the imaging apparatus attached, and once trained may be deployed with or without the imaging apparatus. The imaging apparatus comprise an optical assembly that may magnify the image, an attachment arrangement and a chamber or a wall structure that forms a chamber when placed against an object. The inner surface of the chamber is reflective apart and has a curved profile to create uniform lighting conditions on the one or more objects being imaged and uniform background lighting to reduce the dynamic range of the captured images.

### PRIORITY DOCUMENTS

The present application claims priority from Australian Provisional Patent Application No. 2019902460 titled “AI BASED PHONE MICROSCOPY SYSTEM AND ANALYSIS METHOD” and filed on 11 Jul. 2019, the content of which is hereby incorporated by reference in its entirety.

### TECHNICAL FIELD

The present disclosure relates to an imaging system systems. In a particular form the present disclosure relates to portable imaging systems configured to be attached to smart mobile devices incorporating image sensors.

### BACKGROUND

In many applications it would be desirable to capture images of objects in the field, for example to determine if a fly is a fruit fly, or whether a plant is suffering from a particular disease. Traditional microscopy systems have been large laboratory apparatus with expensive high precision optical systems. However the development of smart phones with compact high quality camera systems and advanced processing capabilities has enabled the development of mobile phone based microscopy systems. In these systems a magnifying lens system is typically attached over the camera system of the phone and used to capture magnified images. However to date, systems have generally been designed for capturing images for manual viewing of images by eye and have typically focussed on creating compact/low profile attachments incorporating lens and optical components. Some systems have used the camera flash to further illuminate the object and improve lighting of the target object. Typically these lighting systems have either used the mobile phone flash, or comprise components located adjacent the image sensor to enable a compact/low profile attachment, and thus are focussed on directing light onto the subject from above. In some embodiments light pipes and diffusers are used to create a uniform plane of light parallel to the mobile phone surface and target surface. i.e. the normal axis of the plane is parallel/aligned with the camera axis. These light pipe and diffuser arrangements are typically compact arrangements located adjacent the magnifying lens (and the image sensor and flash). For example one system uses a diffuser to create ring around the magnifying lens to direct planar light down onto the object.

AI based approaches have also been developed to classify captured images, but to date such systems have failed to have sufficient accuracy when deployed to the field. For example one system attempted to use deep learning methods to automatically classify images taken with a smart phone. In this study a convolutional neural net approach was trained on a database of 54,000 images comprising 26 diseases in 14 crop species. Whilst the deep learning classifier was 99.35% accurate on the test set, this dropped to 30% to 40% when applied to other images such as images captured in the field, or in other laboratories. This suggested that an even larger and more robust dataset is required for deep learning based analysis approaches to be effective. There is thus a need to provide improved systems and methods for capturing and classifying images collected in the field, or to at least a useful alternative to existing systems and methods.

### SUMMARY

According to a first aspect there is provided an imaging apparatus configured to be attached to a mobile computing apparatus comprising an image sensor, the imaging apparatus comprising:

an optical assembly comprising a housing with an image sensor aperture, an image capture aperture and an internal optical path linking the image sensor aperture to the image capture aperture within the housing

an attachment arrangement configured to support the optical assembly and allow attachment of the imaging apparatus to a mobile computing apparatus comprising an image sensor such that the image sensor aperture of the optical assembly can be placed over the image sensor; and

a wall structure extending distally from the optical assembly and comprising an inner surface connected to and extending distally from the image capture aperture of the optical assembly to define an inner cavity, wherein the wall structure is either a chamber that defines the internal cavity and comprises a distal portion which, in use, either supports one or more objects to be imaged or the distal portion is a transparent window which is immersed in and placed against one or more objects to be imaged, or a distal end of the wall structure forms a distal aperture such that, in use, the distal end of the wall structure is placed against a support surface supporting or incorporating one or more objects to be imaged so as to form a chamber, and the inner surface of the wall structure is reflective apart from at least one portion comprising a light source aperture configured to allow light to enter the chamber and the inner surface of the wall structure has a curved profile to create uniform lighting conditions on the one or more objects being imaged and uniform background lighting

wherein, in use, the mobile computing apparatus with the imaging apparatus attached is used to capture and provide one or more images to a machine learning based classification system, wherein the one or more images are either used to train the machine learning based classification system or the machine learning system was trained on images of objects captured using the same or an equivalent imaging apparatus and is used to obtain a classification of the one or more images.

The imaging apparatus can thus be used as a way of obtaining good quality (uniform diffuse lighting) training images for a machine learning classifier that can be used on poor quality images, such as those taken in natural light and/or with high variation in light levels or a large dynamic range. According to a second aspect there is provided a machine learning based imaging system comprising:

an imaging apparatus according to the first aspect; and

a machine learning based analysis system comprising at least one processor and at least one memory, the memory comprising instructions to cause the at least one processor to provide an image captured by the imaging apparatus to a machine learning based classifier, wherein the machine learning based classifier was trained on images of objects captured using the imaging apparatus, and obtaining a classification of the image.

According to a third aspect, there is provided a method for training a machine learning classifier to classify an image captured using an image sensor of a mobile computing apparatus, the method comprising:

attaching an attachment apparatus of an imaging apparatus to a mobile computing apparatus such that an image sensor aperture of an optical assembly of the attachment apparatus is located over an image sensor of the mobile computing apparatus, wherein the imaging apparatus comprises an optical assembly comprising a housing with the image sensor aperture, and an image capture aperture and an internal optical path linking the image sensor aperture to the image capture aperture within the housing and a wall structure with an inner surface, wherein the wall structure either defines a chamber wherein the inner surface defines an internal cavity and comprises a distal portion for either supporting one or more objects to be imaged or a transparent window or a distal end of the wall structure forms a distal aperture and the inner surface is reflective apart from at least one portion comprising a light source aperture configured to allow light to enter the chamber and has a curved profile to create uniform lighting conditions on the one or more objects being imaged and uniform background lighting;

placing one or more objects to be imaged in the chamber such that they are supported by the distal portion, or immersing at least the distal portion of the chamber into a plurality of objects such that one or more objects are located against the transparent window, or placing the distal end of the wall structure against a support surface supporting or incorporating one or more objects to be imaged so as to form a chamber;

capturing a plurality of images of the one or more objects; and

providing the one or more images to a machine learning based classification system and training the machine learning system to classify the one or more objects, wherein in use the machine learning system is used to classify an image captured by the mobile computing apparatus.

According to a fourth aspect there is provided a method for classifying an image captured using an image sensor of a mobile computing apparatus, the method comprising:

capturing one or more images of the one or more objects using the mobile computing apparatus; and

providing the one or more images to a machine learning based classification system to classify the one or more images, wherein the machine learning based classification system is trained according to the method of the third aspect.

The method may optionally include additional steps comprising:

attaching an attachment apparatus to a mobile computing apparatus such that an image sensor aperture of an optical assembly of the attachment apparatus is located over an image sensor of the mobile computing apparatus, wherein the imaging apparatus comprises an optical assembly comprising a housing with the image sensor aperture, and an image capture aperture and an internal optical path linking the image sensor aperture to the image capture aperture within the housing and a wall structure with an inner surface, wherein the wall structure either defines a chamber wherein the inner surface defines an internal cavity or a distal end of the wall structure forms a distal aperture and the inner surface is reflective apart from a portion comprising a light source aperture configured to allow light to enter the chamber and has a curved profile to create uniform lighting conditions on the one or more objects being imaged and uniform background lighting; and

placing one or more objects to be imaged in the chamber, or immersing a distal portion of the chamber in one or more objects, or placing the distal end of the wall structure against a support surface supporting or incorporating one or more objects to be imaged so as to form a chamber.

According to a fifth aspect there is provided a machine learning computer program product comprising computer readable instructions, the instructions causing a processor to:

receive a plurality of images captured using an imaging sensor of a mobile computing apparatus to which an imaging apparatus of the first aspect is attached; and

train a machine learning classifier on the received plurality of images according to the method of the third aspect.

According to a sixth aspect there is provided a machine learning computer program product comprising computer readable instructions, the instructions causing a processor to:

receive one or more images captured using an imaging sensor of a mobile computing apparatus; and

classify the received one or more images using a machine learning classifier trained on images of objects captured using an imaging apparatus of the first aspect attached to an imaging sensor of a mobile computing apparatus according to the method of the fourth aspect.

The above system and method may be varied.

In one form, the optical assembly may further comprise a lens arrangement having a magnification of between up to 400 times. This may include the use of fish eye and wide angle lenses. In one form the lens arrangement may be adjustable to allow adjustment of the focal plane and/or magnification and different angles of view.

In one form, the profile may be curved such that the horizontal component of reflected light illuminating the one or more objects is greater than the vertical component of reflected light illuminating the one or more objects. In one form, the inner surface may form the background. In one form the curved profile may be a spherical profile or near spherical profile. In a further form the inner surface may acts as a Lambertian reflector and the chamber is configured to act as a light integrator to create uniform lighting within the chamber and to provide uniform background lighting. In one form the wall is formed from Polytetrafluoroethylene (PTFE),In one form, the curved profile of the inner surface is configured to uniformly illuminate a 3-Dimensional object within the chamber to minimise or eliminate the formation of shadows. In one form, the inner surface of the chamber forms the background for the 3Dimentional object.

In one form, the wall structure and/or light source aperture is configured to provide uniform lighting conditions within the chamber. In one form, the wall structure and/or light source aperture is configured to provide diffuse light into the internal cavity. The light source aperture may be connected to an optical window extending through the wall structure to allow external light to enter the chamber. and a plurality of particles may be diffused throughout the optical window to diffuse light passing through the optical window. The wall structure may be formed of a light diffusing material such that diffused light enters the chamber via the light source aperture, and/or the wall structure may be formed of a semi-transparent material comprising a plurality of particles distributed throughout the wall to diffuse light passing through the wall, and/or a second light diffusing chamber which partially surrounds at least a portion of the wall structure may be configured (located and shaped) to provide diffuse light to the light source aperture. The diffusion may be achieved by particles embedded within the optical window or the semitransparent wall. In one form, the light source aperture and/or the second light diffusing chamber may be configured to receive light from a flash of the mobile computing apparatus. The amount of light received from the mobile computing apparatus can be controlled using a software program executing on the mobile computing apparatus. In one form, one or more portions of the walls are semi-transparent.

In one form, a programmable multi spectral lighting source many used to deliver the received light, and be controlled by the software app on the mobile computing apparatus. In one form, the system may further comprise one or more filters configured to provide filtered light (including polarised light) to the light source aperture or a multi spectral lighting source configured to provide light in one of a plurality of predefined wavelength bands to the light source aperture to the light source aperture. The multi spectral lighting source may be programmable and/or controlled by the software app on the mobile computing apparatus. A plurality of images may be taken, each using a different filter or different wavelength band. The one or more filters may comprise a polarising filter integrated into or adjacent the light source aperture such that light entering the inner cavity through the light source aperture is polarised, or one or more polarising filters integrated into the optical assembly or across the image capture aperture.

In one form a transparent calibration sheet is located between the one or more objects and the optical assembly, or integrated within the optical assembly. In one form one or more calibration inserts which can be inserted into the interior cavity to calibrate colour and/or depth. In one form, in use a plurality of images are collected at a plurality of different focal planes and the analysis system is configured to combine the plurality of images into a single multi depth image. In one form, in use a plurality of images are collected of different parts of the one or more objects and the analysis system is configured to combine the plurality of images into a single stitched image. In one form, the analysis system is configured to perform a colour measurement. In one form, the analysis system is configured to capture an image without the one or more objects in the chamber, and uses the image to adjust the colour balance of an image with the one or more objects in the chamber. In one form, the analysis system detects the lighting level within the chamber and captures images when the lighting level is within a predefined range.

In one form, the wall structure is an elastic material and in use, the wall structure is deformed to vary the distance to the one or more objects from the optical assembly and a plurality of images are collected at a range of distances. In one form, in use, the support surface is an elastic object and a plurality of images is collected at a range of pressure levels applied to the elastic object.

In one form, the chamber is removable from the attachment arrangement to allow one or more objects to be imaged to be placed in the chamber. In one form, the chamber comprises a removable cap to allow one or more objects to be imaged to be placed inside the chamber. In one form, the chamber comprises a floor further comprising a depression centred on an optical axis of the lens arrangement. In one form, a floor portion of the chamber is transparent. In one form, the floor portion is includes a measurement graticule.

In one form, the chamber further comprises an inner fluid chamber with transparent walls aligned on an optical axis and one or more tubular connections are connected to a liquid reservoir. In use the inner fluid chamber is filled with a liquid and the one or more objects to be imaged are suspended in the liquid in the inner fluid chamber, and the one or more tubular connections are configured to induce circulation within the inner fluid chamber to enable capturing of images of the object from a plurality of different viewing angles.

In one form, the wall structure is a foldable wall structure comprising an outer wall structure comprises of a plurality of pivoting ribs, and the inner surface is a flexible material and one or more link members connect the flexible material to the outer wall structure such that when in an unfolded configuration the one or more link members are configured to space the inner surface from the outer wall structure and one or more tensioning link members pull the inner surface to adopt the curved profile.

In one form, the wall structure is a translucent bag and the apparatus further comprises a frame structure comprised of ring structure located around the image capture aperture and a plurality of flexible legs which in use can be configured to adopt a curved configuration to force the wall of the translucent bag to adopt the curved profile. In a further form a distal portion of the translucent bag comprises or in use supports a barcode identifier and one or more colour calibration regions.

In one form, the machine learning classifier is configured to classify an object according a predefined quality assessment classification system. In a further form the system is further configured to assess one or more geometrical, textual and/or colour features of an object to perform a quality assessment on the one or more objects. These features may be used to assess weight or provide a quality score.

In one form, the mobile computing apparatus may be a smartphone or a tablet computing apparatus. In one form the mobile computing apparatus comprises an image sensor without an Infrared Filter or UV Filter.

The attachment arrangement may be a removable attachment arrangement, including a clipping arrangement configured to clip onto the mobile computing apparatus. In one form, attachment arrangement is a clipping arrangement in which one end comprises a soft clamping pad with a curved profile. In one form, the clipping arrangement comprises a rocking arrangement to allow the optical axis to rock against the clip. In one form the soft clamping pad is further configured to act as a lens cap for the image sensor aperture.

### BRIEF DESCRIPTION OF DRAWINGS

Embodiments of the present disclosure will be discussed with reference to the accompanying drawings wherein:

FIG. 1A is a flow chart of a method for training a machine learning classifier to classify an image captured using an image sensor of a mobile computing apparatus according to an embodiment;

FIG. 1B is a flow chart of a method for classifying an image captured using an image sensor of a mobile computing apparatus according to an embodiment;

FIG. 2A is a schematic diagram of an imaging apparatus according to an embodiment;

FIG. 2B is a schematic diagram of an imaging apparatus according to an embodiment;

FIG. 2C is a schematic diagram of an imaging apparatus according to an embodiment;

FIG. 3 is a schematic diagram of a computer system for analysing captured images according to an embodiment;

FIG. 4A is a side view of an imaging apparatus according to an embodiment;

FIG. 4B is a side view of an imaging apparatus according to an embodiment;

FIG. 4C is a side view of an imaging apparatus according to an embodiment;

FIG. 4D is a close up view of the swing mechanism and cover shown in FIG. 4C according to an embodiment;

FIG. 4E is a side view of an imaging apparatus according to an embodiment;

FIG. 4F is a perspective view of an imaging apparatus incorporating a double chamber according to an embodiment;

FIG. 4G is a perspective view of a calibration insert according to an embodiment;

FIG. 4H is a side sectional view of an imaging apparatus for inline imaging of a liquid according to an embodiment;

FIG. 4I is a side sectional view of an imaging apparatus for imaging a sample of a liquid according to an embodiment;

FIG. 4J is a side sectional view of an imaging apparatus with an internal tube for suspending and three dimensional imaging of an object according to an embodiment;

FIG. 4K is a side sectional view of an imaging apparatus for immersion in a container of objects to be imaged according to an embodiment;

FIG. 4L is a side sectional view of a foldable removable imaging apparatus for imaging of large objects according to an embodiment;

FIG. 4M is a perspective view of an imaging apparatus in which the wall structure is a bag with a flexible frame for assessing quality of produce according to an embodiment;

FIG. 4N is a side sectional view of a foldable imaging apparatus configured as a table top scanner according to an embodiment;

FIG. 4O is a side sectional view of a foldable imaging apparatus configured as a top and bottom scanner according to an embodiment;

FIG. 5A shows a natural lighting test environment according to an embodiment;

FIG. 5B shows a shadow lighting test environment according to an embodiment; and

FIG. 5C shows a chamber lighting test environment according to an embodiment;

FIG. 5D shows an image of an object captured under the natural lighting test environment of FIG. 5A according to an embodiment;

FIG. 5E an image of an object captured under the shadow lighting test environment of FIG. 5B;

FIG. 5F shows an image of an object captured under the chamber lighting test environment of FIG. 5C;

FIG. 6 is a representation of a user interface according to an embodiment;

FIG. 7 is a plot of the relative sensitivity of a camera sensor and the human eye according to an embodiment; and

FIG. 8 is a representation of the dynamic range of images captured using the imaging apparatus and in natural lighting according to an embodiment.

In the following description, like reference characters designate like or corresponding parts throughout the figures.

### DESCRIPTION OF EMBODIMENTS

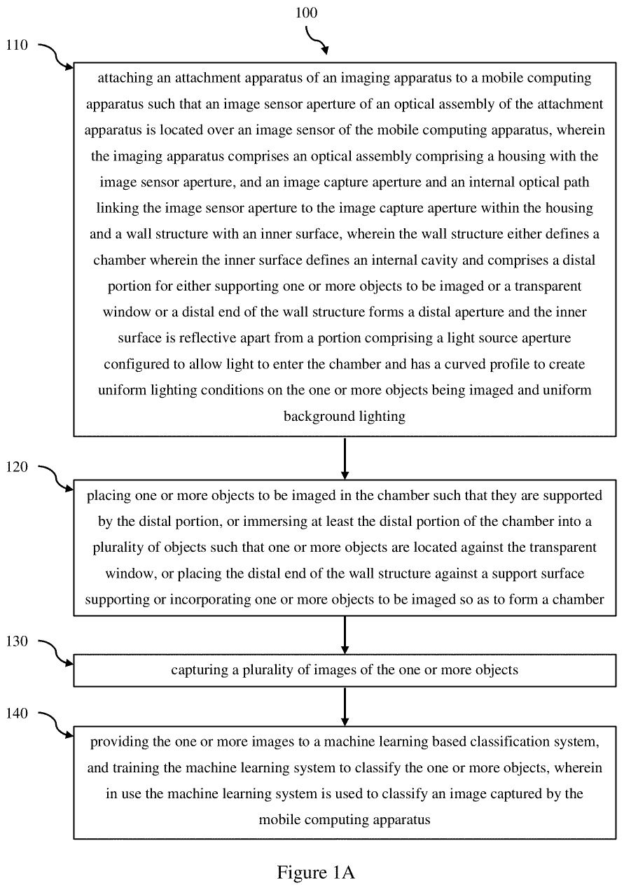

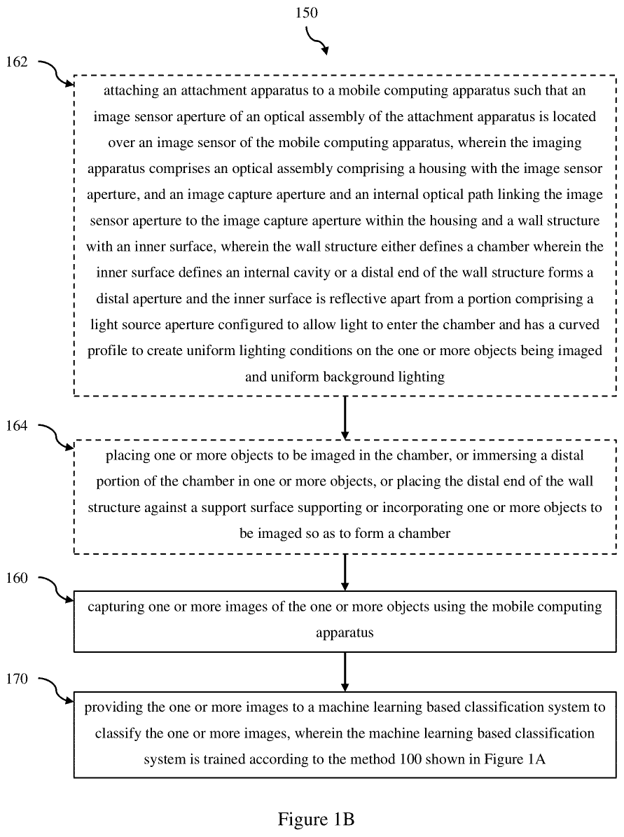

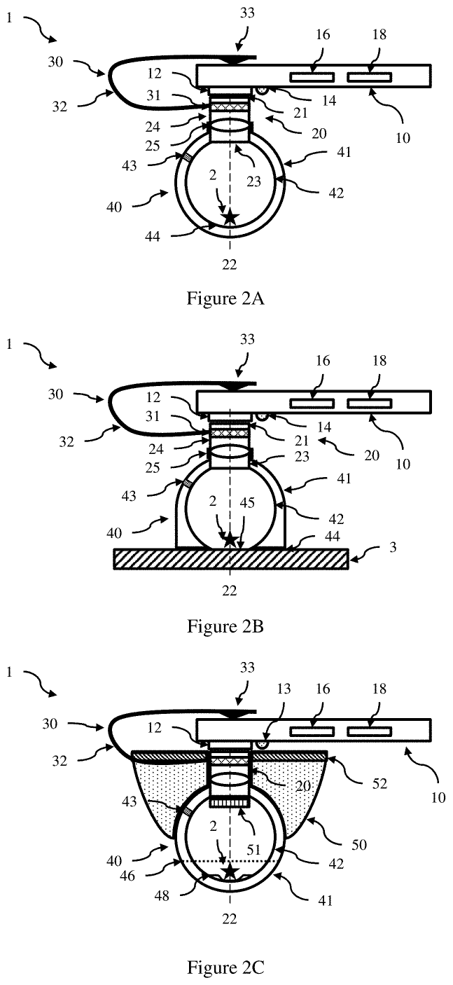

Referring now to FIGS. 1A and 1B, there is shown a flow chart of a method 100 for training a machine learning classifier to classify an image (FIG. 1A) and a method 150 for classifying an image captured using a mobile computing apparatus incorporating an image sensor such as a smartphone or tablet (FIG. 1B). This method is further illustrated by FIGS. 2A to 2 C which are a schematic diagram of various embodiments of an imaging apparatus 1 for attaching to such a mobile computing apparatus which is configured (e.g. through the use of specially designed wall structure or chamber) to generate uniform lighting conditions on an object. The imaging apparatus 1 could thus be referred to as uniform lighting imaging apparatus however for the sake of clarity we will refer to it as simply an imaging apparatus. The method begins with step 110 of placing an attachment arrangement, such as a clip 30 of the imaging apparatus 1 on a mobile computing apparatus (e.g. smartphone) 10 such that an image sensor aperture 21 of an optical assembly 20 of the attachment apparatus 1 is located over an image sensor, such as a camera, 12 of the mobile computing apparatus 10. This may be a permanent attachment, a semi-permanent or use a removable attachment. In the case of permanent attachment this may be performed at the time of manufacture. The attachment arrangement may be used to support the mobile computing apparatus, or the mobile computing apparatus may support the attachment arrangement. The attachment arrangement may be based on fasteners (e.g. screws, nuts and bolts, glue, welding), clipping, clamping, suction, magnetics, or a re-usable sticky material such as washable silicone (PU), or some combination, which is configured or adapted to grip or hold the camera to align the image sensor aperture 21 with the image sensor 12. Preferably the attachment arrangement applies a bias force to bias the image sensor aperture 21 towards the image sensor 12 to create a seal, a barrier or contact that excludes or mitigates external light from reaching the image sensor 12.

The imaging apparatus comprises an optical assembly 20 comprising a housing 24 with an image sensor aperture 21 at one end and an image capture aperture 23 at another end of the housing and an internal optical path 26 linking the image sensor aperture 12 to the image capture aperture within the housing 24. The attachment arrangement is configured to support the optical assembly, and allow the image sensor aperture 21 to be placed over the image sensor 12 of the mobile computing apparatus 10. In some embodiment the optical path is a straight linear path aligned to an optical axis 22. However in other embodiments the housing could include mirrors to provide a convoluted (or at least a not straight) optical path. e.g. the image sensor aperture 21 and the image capture aperture 23 are not both aligned with an optical axis 22. In some embodiments, the optical assembly 20 further comprises a lens arrangement having a magnification of up to 400 times. This may include fish eye and wide angle lens (with magnifications less than 1) and/or lens with different angles of view (or different fields of view). In some embodiments the lens arrangement could be omitted and the lens of the image sensor used provided it has sufficient magnification or if magnification is not required. The total physical magnification of the system will be the combined magnification of the lens arrangement and any lens of the mobile computing apparatus. The mobile computing apparatus may also perform digital magnification. In some embodiments the lens arrangement is adjustable to allow adjustment of the focal plane and/or magnification. This may be manually adjustable, or electronically adjustable through incorporation of electronically controllable motors (servos). This may further include a wired or wireless communications module, to allow control via a software application executing on the mobile computing apparatus.

The imaging apparatus 1 comprises wall structure 40 with an inner surface 42. In one embodiment, such as that shown in FIG. 2A, this wall structure is a chamber in which the inner surface 42 defines an internal cavity. A distal (or floor) portion 44 is located distally opposite the optical assembly 20 and supports one or more objects to be imaged. In one embodiment such as that shown in FIG. 2B, the wall structure 40 is open and a distal end of the walls (i.e. the distal portion 44) forms a distal aperture 45 which in use is placed against a support surface 3 which supports or incorporates one or more objects to be imaged so as to form a chamber. In another embodiment the distal portion 44 is a transparent window such that when the apparatus is immersed in and placed against one or more objects to be imaged (for example seeds in a container) such that the surrounding one or more objects will obscure external light from entering the chamber. An inner surface 42 of the wall structure is reflective apart from a portion comprising a light source aperture 43 configured to allow light to enter the chamber. Further the inner surface 42 of the wall structure 40 has a curved profile to create both uniform lighting conditions on the one or more objects being imaged and uniform background lighting. For the sake of clarity, we will typically refer to a single object being imaged. However in many embodiments, several objects may be placed within the chamber and be captured (and classified) in the same image.

The wall structure is configured to create uniform lighting within the chamber and uniform background lighting on the object(s) to imaged. As discussed below this may limit the dynamic range of the image, and may reduce the variability in the lighting conditions of captured images to enable faster and more accurate and robust training of a machine learning classifier. In some embodiments, the inner surface 42 of the wall structure 40 is spherical or near spherical and acts as a Lambertian reflector such that the chamber is configured to act as a light integrator to create uniform lighting within the chamber and uniform background lighting on the object(s). A Lambertian reflector is a reflector that has the property that light hitting the sides of the sphere is scattered in a diffuse way. That is there is uniform scattering of light in all directions. Light integrators are able to create uniform lighting by virtue of multiple internal reflections on a diffusing surface. Light integrators are substantially spherical in shape and use Lambertian reflector causing the intensity of light reaching the object to be similar in all directions. The inner surface of the wall surface may be coated with a reflective material, or it may be formed from a material that acts as Lambertian reflector such as Polytetrafluoroethylene (PTFE). In the case of a light integrator the size of the light source aperture 43 that allows light into the chamber is typically limited to less than 5% of the total surface area. Thus in some embodiments the light source aperture 43 is less than 5% of the surface area of the inner surface 42. If the light entering the chamber is not already diffused, then baffles may be included to ensure only reflected light illuminates the object.

Deviations from Lambertian reflectors and purely spherical profiles can also be used in which the inner wall profile is curved so as to increase the horizontal component of reflected light illuminating the object. In some embodiments the horizontal component of reflected light illuminating the object is greater than the vertical component of reflected light illuminating the object. In some embodiments the wall structure is configured to eliminate shadows to uniformly illuminate a 3-Dimensional object within the chamber from all directions. Also in some embodiments the size of the light source aperture 43 or total size of multiple light source apertures 43 may be greater than 5%, such as 10%, 15%, 20%, 25% or 30%. Multiple light source apertures 43 may be used as well as diffusers in order to increase the horizontal component of reflected and/or diffused light illuminating the object and eliminate shadowing.

At step 120 the method comprises placing one or more objects 2 to be imaged in the chamber 40 such that they are supported by the distal or floor portion 44, or immersing at least the distal portion of the chamber into a container filled with multiple objects (i.e. into a plurality of objects) such that the objects are located against the transparent window. Alternatively if the distal portion 44 is an open aperture 45, the distal end of the wall structure 40 may be placed against a support surface 3 supporting or incorporating an object 2 to be imaged so as to form a chamber (e.g. such as that shown in FIG. 2B). The chamber may be a removable chamber, for example it may clip onto or screw onto the optical assembly, allowing an object to be imaged to be placed inside the chamber via the aperture formed where the chamber meets the optical assembly such as that shown in FIG. 2A. FIG. 2C shows another embodiment in which the wall structure forms a chamber in which the end of the chamber is formed as a removable cap 46. This may screw on or clip on or use some other removable sealing arrangement. In some embodiments a floor portion 48 (such as that shown in FIG. 2C) may further comprise a depression centred on an optical axis 22 of the lens arrangement 20 which acts a locating depression. Thus the chamber could be shaken and the object will then be likely to fall into the locating depression to ensure it is aligned with the optical axis 22.

At step 130 one or more images of the object(s) are captured and at step 140 the one or more captured images are provided to a machine learning based classification system. The images captured using the imaging apparatus 1 are then used to training the machine learning system to classify the one or more objects for deployment to a mobile computing apparatus 10 which in use will classify captured images.

FIG. 1B is a flowchart of a method 150 for classifying an image captured using a mobile computing apparatus incorporating an image sensor such as a smartphone or tablet. This uses the machine learning classifier trained according to the method shown in FIG. 1A. This in use method comprises step 160 of capturing one or more images of the one or more objects using the mobile computing apparatus 10, and then providing the one or more images to an machine learning based classification system to classify the one or more images where the machine learning classifier was trained on images captured using the imaging apparatus 1 attached to a mobile computing apparatus 10. As will be further elaborated below, in this embodiment the classification of images does not require the images (to be classified) to be captured using a mobile computing apparatus 10 to which the imaging apparatus 1 was attached (only that the classifier was trained using the apparatus).

However in another (optional) embodiment, the images may be captured using a mobile computing apparatus 10 to which the imaging apparatus 1 was attached, which is the same or equivalent as the imaging apparatus 1 used to train the machine learning classifier. In this embodiment the method begins with step 162 of attaching an imaging apparatus 1 to a mobile computing apparatus 10 such that an image sensor aperture of an optical assembly of the attachment apparatus is located over an image sensor of the mobile computing apparatus. The imaging apparatus is as described previously (and equivalent to the apparatus used to train the classifier) and comprises an optical assembly comprising a housing with the image sensor aperture, and an image capture aperture and an internal optical path linking the image sensor aperture to the image capture aperture within the housing and a wall structure with an inner surface. The wall structure either defines a chamber such that the inner surface defines an internal cavity where the distal portion supports an object to be imaged or is transparent for immersion application, or the distal portion forms a distal aperture. The inner surface is reflective apart from a portion comprising a light source aperture configured to allow light to enter the chamber and has a curved profile to create uniform lighting conditions on the one or more objects being imaged and uniform background lighting. Then at step 164 one or more objects to be imaged are placed in the chamber, or a distal portion of the chamber is immersed in one or more objects (e.g. located in a container), or placing the distal end of the wall structure against a support surface supporting or incorporating one or more objects to be imaged so as to form a chamber. The method then continues with step 160 of capturing images and then step 170 of classifying the images.

The machine learning system is configured to output a classification of the image, and may also provide additional information on the object, such as estimating one or more geometrical, textual and/or colour features. These may be used to estimate weight, dimensions or size, as well as assess quality (or obtain a quality score). The system may also be used to perform real time or point of sale quality assessment. The classified may be trained or configured to classify an object according to a predefined quality assessment classification system, such as one defined by a purchaser or merchant. For example this could specify size ranges, colour ranges, number of blemishes, etc.

The use of chamber which has reflective walls and has a curved or spherical profile to create uniform lighting conditions on the object being imaged, thus eliminating any shadows and reducing the dynamic range of the image, improves the performance of the machine learning classification system. This also reduces the number of images required to train the system, and ensures uniformity of lighting of images whether taken indoors or outdoors. Effectively the chamber acts as or approximates an integrating sphere and ensures all surfaces, including under and side surfaces are uniformly illuminated (i.e. light comes from the sides, not just from above). This also reduces the dynamic range of the image. This is in contrast to many other systems which attempt to generate planar light or diffuse light directed downwards from the lens arrangement, and fail to generate light from the sides or generate uniform lighting conditions, and/or generate intensity values spanning a comparatively large dynamic range. The horizontal component of the diffused lighting helps in eliminating shadows and this component is not generated by reflector designs that are generally used with mobile phone attachments. In the embodiments where the wall structure is a chamber the inner surface 42 thus forms the background of the image.

In such prior art systems light may reflect off the support surface and create shadows on the object. As the location and intensity of these shadows will vary based on the geometry of the object and where it is placed, the present systems eliminates the effects of possible shadowing so that both training set images and in field images are more uniform, thus ensuring that the machine learning classification system does not erroneously identify shadow features and can thus focus on detecting more robust distinguishing features. In particular the current system is designed to eliminate shadows and background variations to improve the performance and reliability (robustness) of the AI/machine learning classification system.

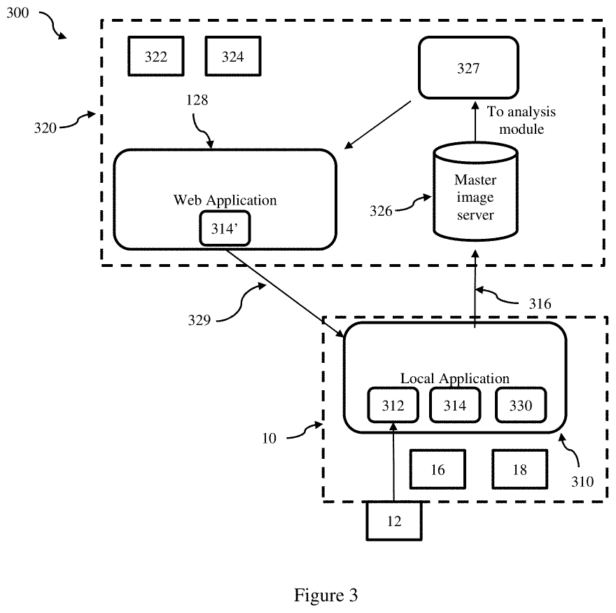

FIG. 3 is a schematic diagram of a computer system 300 for training and analysing captured images using a machine learning classifier according to an embodiment. The system comprises a mobile computing apparatus 10, such as smartphone or tablet comprising a camera 12, a flash 14, at least one processor 16 and at least one memory 18. The mobile computing apparatus 10 executes a local application 310 that is configured to control capture of images 312 by the smartphone and to perform classification using a machine learning based classifier 314 that was trained on images collected using embodiments of the imaging apparatus described herein. These may be connected over wired or wireless communication links. A remote computing system 320, such as a cloud based system comprising one or more processors 322 and one or more memories 324. A master image server 326 stores images received from smartphones, along with any relevant metadata such as labels (for use in training), project, classification results, etc. The stored images are provided to a machine learning analysis module 327 that is trained on the captured images. A web application 328 provides a user interface into the system, and allows a user to download 329 a trained machine learning classifier to their smartphone for infield use. In some embodiments the training of a machine learning classifier could be performed on the mobile computing apparatus, and the functionality of the remote computing apparatus could be provided by the mobile computing apparatus 10.

This system can be used to allow a user to train a machine learning system specific to their application, for example by capturing a series of training images using their smartphone (with the lens arrangement attached) which are uploaded to the cloud system along with label information, and this is used to train a machine learning classifier which is downloaded to their smartphone. Further as more images are captured, these can be added to the master image store, and the classifier retrained and then and updated version can be downloaded to their smartphone. Further the classifier can also be made available to other users, for example from the same organisation.

The local application 310 may be an “App” configured to execute on the smart phone. The web application 328 may provide a system user interface as well as licensing, user accounts, job coordination, analysis review interface, report generation, archiving functions, etc. The web application 328 and the local application 310 may exchange messages and data. In one embodiment the remote computing apparatus 320 could be eliminated, and image storage and training of the classifier could be performed on the smart phone 10. In other embodiments, the analysis module 327 could also be a distributed module, with some functionality performed on the smartphone 10 and some functionality by the remote computing apparatus 320. For example image quality assessment or image pre-processing could be provided locally and training of images could be performed remotely. In some embodiments training of the machine learning classifier could be performed using the remote computing application (e.g. on a cloud server or similar), and once a trained machine learning classifier is generated, then the classifier is deployed to the smartphone App 310. In this embodiment the local App 310 operates independently and is configured to capture and classify images (using the locally stored trained classifier) without the need for a network connection or communication link back to the remote application 327.

Each computing apparatus comprises at least one processor 16 and at least one memory 18 operatively connected to the at least one processor (or one of the processors) and may comprise additional devices or apparatus such as a display device, and input and output devices/apparatus (the term apparatus and device will be used interchangeably). The memory may comprise instructions to cause the processor to execute a method described herein. The processor memory and display device may be included in a standard smartphone device, and the term mobile computing apparatus will refer to a range of smartphone computing apparatus including phablets and tablet computing systems as well as a customised apparatus or system based on smartphone or tablet architecture (e.g. a customised android computing apparatus). The computing apparatus may be a unitary computing or programmable apparatus, or a distributed apparatus comprising several components operatively (or functionally) connected via wired or wireless connections including cloud based computing systems. The computing apparatus may comprise a central processing unit (CPU), comprising an Input/Output Interface , an Arithmetic and Logic Unit (ALU) and a Control Unit and Program Counter element which is in communication with input and output devices through an Input/Output Interface. The input and output devices may comprise a display, a keyboard, a mouse, a stylus etc.

The Input/Output Interface may also comprise a network interface and/or communications module for communicating with an equivalent communications module in another apparatus or device using a predefined communications protocol (e.g. 3G, 4G, WiFi, Bluetooth, Zigbee, IEEE 802.15, IEEE 802.11, TCP/IP, UDP, etc.). A graphical processing unit (GPU) may also be included. The display apparatus may comprise a flat screen display such as touch screen or other LCD or LED display. The computing apparatus may comprise a single CPU (core) or multiple CPU's (multiple core), or multiple processors. The computing apparatus may use a parallel processor, a vector processor, or be a distributed computing apparatus including cloud based servers. The memory is operatively coupled to the processor(s) and may comprise RAM and ROM components, and may be provided within or external to the apparatus. The memory may be used to store the operating system and additional software modules or instructions. The processor(s) may be configured to load and executed the software modules or instructions stored in the memory.

The desktop and web applications are developed and built using a high level language such as C++, JAVA, etc. including the use of toolkits such as Qt. In one embodiment the machine learning classifier 327 uses computer vision libraries such as OpenCV. Embodiments of the method use machine learning to build a classifier (or classifiers) using reference data sets including test and training sets. We will use the term machine learning broadly to cover a range of algorithms/methods/techniques including supervised learning methods and Artificial Intelligence (AI) methods including convolutional neural nets and deep learning methods using multiple layered classifiers and/or multiple neural nets. The classifiers may use various image processing techniques and statistical technique such as feature extraction, detection/segmentation, mathematical morphology methods, digital image processing, objection recognition, feature vectors, etc. to build up the classifier. Various algorithms may be used including linear classifiers, regression algorithms, support vector machines, neural networks, Bayesian networks, etc. Computer vision or image processing libraries provide functions which can be used to build a classifier such as Computer Vision System Toolbox, MATLAB libraries, OpenCV C++ Libraries, ccv C++ CV Libraries, or ImageJ Java CV libraries and machine learning libraries such as Tensorflow, Caffe, Keras, PyTorch, deeplearn, Theano, etc.

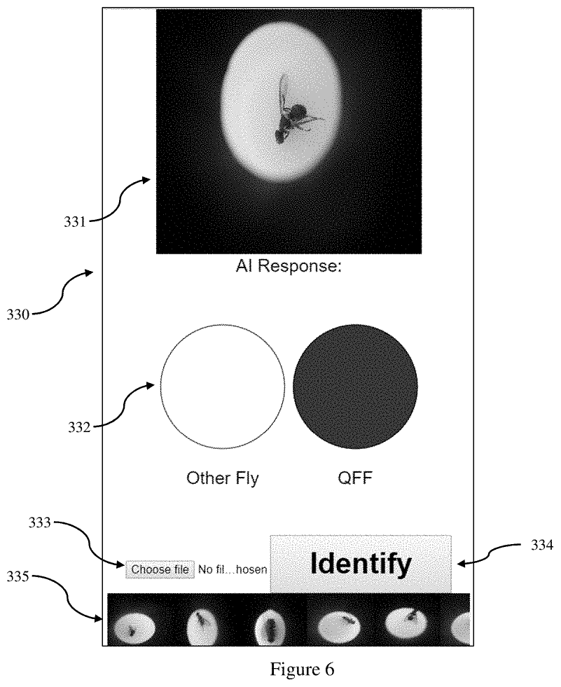

FIG. 6 shows an embodiment of a user interface 330 for capturing images on a smart phone. A captured image 331 is shown in the top of the UI with two indicators 332 which indicate if the captured object is classified as the target (in this case a QFF) or not. User interface controls allow a user to choose a file for analysis 333 and to initiate classification 334. Previously captured images are shown in the bottom panel 335.

Machine learning (also referred to as Artificial Intelligence) covers a range of algorithm that enables machines to self-learn a task (e.g. create predictive models), without human intervention or being explicitly programmed. These are trained to find patterns in the training data by weighting different combination of features (often using combinations of pre-calculated feature descriptors), with the resulting trained model mathematically capturing the best or most accurate pattern for classifying an input image. Machine learning includes supervised machine learning or simply supervised learning methods which learns patterns in labelled training data as well as deep learning methods which use artificial “neural networks” to identify patterns in data and can be used to classify images.

Machine learning includes supervised machine learning or simply supervised learning methods which learns patterns in labelled training data. During training the labels or annotations for each data point (image) relates to a set of classes in order to create a predictive model or classifier that can be used to classify new unseen data. A range of supervised learning methods may be used including Random Forest, Support Vector Machines, decision tree, neural networks, k-nearest neighbour, linear discriminant analysis, naïve Bayes, and regression methods. Typically a set of feature descriptors are extracted (or calculated) from an image using computer vision or image processing libraries and the machine learning method are trained to identify the key features of the images which can be used to distinguish and thus classify image. These feature descriptors may encode qualities such as pixel variation, gray level, roughness of texture, fixed corner points or orientation of image gradients. Additionally, the machine learning system may pre-process the image such as by performing one or more of alpha channel stripping, padding or bolstering an image, normalising, thresholding, cropping or using an object detector to estimate a bounding box, estimating geometric properties of boundaries, zooming, segmenting, annotating, and resizing/rescaling of images. A range of computer vision feature descriptors and pre-processing methods are implemented in OpenCV or similar image processing libraries. During machine learning training models are built using different combinations of features to find a model that successfully classifies input images.

Deep learning is a form of machine learning/AI that goes beyond machine learning models to better imitate the function of a human neural system. Deep learning models typically consist of artificial “neural networks”, typically convolutional neural networks that contain numerous intermediate layers between input and output, where each layer is considered a sub-model, each providing a different interpretation of the data. In contrast to many machine learning classification methods which calculate and use a set of feature descriptors and labels during training, deep learning methods ‘learn’ feature representations from the input image which can then be used to identify features or objects from other unknown images. That is a raw image is sent through the deep learning network, layer by layer, and each layer would learn to define specific (numeric) features of the input image which can be used to classify the image. A variety of deep learning models are available each with different architectures (i.e. different number of layers and connections between layers) such as residual networks (e.g. ResNet-18, ResNet-50 and ResNet-101), densely connected networks (e.g. DenseNet-121 and DenseNet-161), and other variations (e.g. InceptionV4 and Inception-ResNetV2). Training involves trying different combinations of model parameters and hyper-parameters, including input image resolution, choice of optimizer, learning rate value and scheduling, momentum value, dropout, and initialization of the weights (pre-training). A loss function may be defined to assess performing of a model, and during training a Deep Learning model is optimised by varying learning rates to drive the update mechanism for the network's weight parameters to minimize an objective/loss function. The main disadvantage of deep learning methods is that they require much larger training datasets than many other machine learning methods.

Training of a machine learning classifier typically comprises:
a) Obtaining a dataset of images along with associated classification labels;
b) Pre-processing the data, which includes data quality techniques/data cleaning to remove any label noise or bad data and preparing the data so it is ready to be utilised for training and validation;
c) Extract features (or a set of feature descriptors) for example by using computer vision/image processing methods;
d) Choosing a model configuration, including model type/architecture and machine learning hyper-parameters;
e) Splitting the dataset into a training dataset and a validation dataset and/or a test dataset;
f) Training the model by using a machine learning algorithm (including using neural network and deep learning algorithm) on the training dataset; typically, during the training process, many models are produced by adjusting and tuning the model configurations in order to optimise the performance of model according to an accuracy metric;
g) Choosing the best “final” model based on the model's performance on the validation dataset; the model is then applied to the “unseen” test dataset to validate the performance of the final machine learning model.

Typically accuracy is assessed by calculating the total number of correctly identified images in each category, divided by the total number of images, using a blind test set. Numerous variations on the above training methodology may be used as would be apparent to the person of skill in the art. For example in some embodiments only a validation and test dataset may be used in which the dataset is trained on a training dataset, and the resultant model applied to a test dataset to assess accuracy. In other cases training the machine learning classifier may comprise a plurality of Train-Validate Cycles. The training data is pre-processed and split into batches (the number of data in each batch is a free model parameter but controls how fast and how stably the algorithm learns). After each batch, the weights of the network are adjusted, and the running total accuracy so far is assessed. In some embodiment weights are updated during the batch for example using gradient accumulation. When all images have been assessed, one Epoch has been carried out, and the training set is shuffled (i.e. a new randomisation with the set is obtained), and the training starts again from the top, for the next epoch. During training a number of epochs may be run, depending on the size of the data set, the complexity of the data and the complexity of the model being trained. After each epoch, the model is run on the validation set, without any training taking place, to provide a measure of the progress in how accurate the model is, and to guide the user whether more epochs should be run, or if more epochs will result in overtraining. The validation set guides the choice of the overall model parameters, or hyperparameters, and is therefore not a truly blind set. Thus at the end of the training the accuracy of the model may be assessed on a blind test dataset.

Once a model is trained it may be exported as an electronic data file comprising a series of model weights and associated data (e.g. model type). During deployment the model data file can then be loaded to configure a machine learning classifier to classify images.

In some embodiments the machine learning classifier may be trained according to a predefined quality assessment classification system. For example a merchant could define one or more quality classes for produce, with associated criteria for each class. For example for produce such as apples this may be a desired size, shape, colour, number of blemishes, etc. A classifier could be trained to implement this classification scheme, and then used by a grower, or at the point of sale to classify the produce to ensure it is acceptable or to automatically determine the appropriate class. The machine learning classifier could also be configured to estimate additional properties such as size or weight. For example the size/volume can be estimated by capturing multiple images each from different viewing angles and using image reconstruction/computer vision algorithms to estimate the three dimensional volume. This may be further assisted by the use of calibration objects located in the field of view. Weight can also be estimated based on known density of materials.

The software may be provided as a computer program product, such an executable file (or files) comprising computer (or machine) readable instructions. In one embodiment the machine learning training system may be provided as a computer program product which can be installed and implemented on one or more servers, including cloud servers. This may be configured to receive a plurality of images captured using an imaging sensor of a mobile computing apparatus to which an imaging apparatus of the first aspect is attached, and then train a machine learning classifier on the received plurality of images according to the method shown in Figure IA and described herein. In another embodiment, the trained classifier system may be provided as a machine learning computer program product which can be installed on mobile computing device such as smartphone. This may be configured to receive one or more images captured using an imaging sensor of a mobile computing apparatus and classify the received one or more images using a machine learning classifier trained on images of objects captured using an imaging apparatus attached to an imaging sensor of a mobile computing apparatus according to the method shown in FIG. 1B.

In one embodiment the attachment arrangement 30 comprises a clip 30 that comprise an attachment ring 31 that surrounds the housing 24 of optical assembly 20 and includes a resilient strap 32 that loops over itself and is biased to direct the clip end 33 towards the optical assembly 20. This attachment arrangement may be a removable attachment arrangement and may be formed of an elastic plastic or metal structure. In other embodiments the clip could be a spring based clip, such as a bulldog clip or clothes peg type clip. The clip could also use a magnetic clipping arrangement. The clip should grip the smartphone with sufficient strength to ensure that the lens arrangement stays in place over the smartphone camera. Clamping arrangements, suction cup arrangement, or a re-usable sticky material such as washable silicone (PU) could also be used to fix the attachment arrangement in place. In some embodiments the attachment arrangement 30 grips the smartphone allowing it to be inserted into a container of materials, or holds the smartphone in a fixed position on a stand or support surface.

The optical assembly 20 comprises a housing that aligns the image capture aperture 21 and lenses 24 (if present) with the smartphone camera (or image sensor) 12 in order to provide magnification of images. The image capture aperture 23 provides an opening into the chamber, and defines the optical axis 22. The housing may be a straight pipe in which the image capture aperture 21, image capture aperture 23 are both aligned with the optical axis 22. In other embodiments mirrors could be used to create a bent or convoluted optical path. The optical assembly may provide magnification in the range from 1× to 200× and may be further increased magnified by lenses in the imaging sensor (e.g. to give total magnification from 1 to 400× or more). The optical assembly may comprise one or more lens 24. In some embodiments the lens 24 could be omitted if magnification is not required or sufficient magnification is provided in the smart phone camera in which case the lens arrangement is simply a pipe designed to locate over the smart phone camera and exclude (or minimise) external entry of light into the chamber. The optical assembly may be configured to include a polariser 51 for example located at the distal end of the lens arrangement 20. Additionally colour filters may also be placed within the housing 20 or over the image capture aperture 23.

As outlined above, a chamber is formed to create uniform lighting conditions on the object to be imaged. In one embodiment a light source aperture 43 is connected to an optical window extending through the wall structure to allow external light to enter the chamber. This is illustrated in FIG. 2A, and allows ambient lighting. In some embodiments the diameter of the light source apertures 43 is less than 5% of the surface area of the inner surface 42. In terms of creating uniform lighting the number of points of entry or the location of light entry does not matter. Preferably no direct light from the light source is allowed to illuminate the object being captured, and light entering the chamber is either forced to reflect of the inner surface 42 or is diffused. The thickness of the material forming the inner surface 42, its transparency and the distribution of light source apertures 43 can be adjusted to ensure uniform lighting. In some embodiments particles are diffused throughout the optical window 43 to diffuse light passing through the optical window. In some embodiments the wall structure 40 is formed of a semi-transparent material comprising a plurality of particles distributed throughout the wall to diffuse light passing through the wall. Polarisers, colour filters or a multispectral LED could also be integrated into the apparatus and used to control properties of the light that enters the chamber via the optical window 43 (and which is ultimately captured by the camera 12)

In another embodiment a light pipe may be connected from the flash 14 of the smartphone to the light source aperture 43. In another embodiment the light pipe may collect light from the flash. In some embodiments the smartphone app 310 may control the triggering of the flash, and the intensity of the flash. Whilst a flash can be used to create uniform light source intensity, and thus potentially provide standard lighting conditions across indoor (lab) and outdoor collection environments, in many cases they provide excessive amounts of light. Thus the app 310 may control the flash intensity, or light filters or attenuators may be used to reduce the intensity of light from the flash or keep the intensity values within a predefined dynamic range. In some cases the app 310 may monitor the light intensity and use the flash if the ambient lighting level is below a threshold level. In some embodiments a multi-spectral light source configure to provide light to the light source aperture is included. The software App executing on the mobile computing apparatus 10 is then used to control the multi-spectral light source, such as which frequency to use to illuminate the object. Similarly a sequence of images may be capture in which each image is captured at a different frequency or spectral band.

In one embodiment the wall structure is formed of a light diffusing material such that diffused light enters the chamber via the light source aperture. For example the wall structure may be constructed of a diffusing material. The outer surface 41 may be translucent or include a light collecting aperture to collect ambient light or include a light pipe connected to the flash 14, an entering light then diffuses through the interior of the wall structure between outer surface 41 and inner surface 42 where it enters the chamber via light source aperture 43.

As shown in FIG. 2C, the imaging apparatus may comprise a second light diffusing chamber 50 which partially surrounds at least a portion of the wall structure and is configured to provide diffuse light to the light source aperture 43. In one embodiment the second light diffusing chamber is configured to receive light from the flash 14. Internal reflecting can then be used to diffuse the lighting within this chamber before it is delivered to the internal cavity (the light integrator).

Optical filters may be used to change the frequency of the light used for imaging and polarized filter can be used to reduce the component of the reflected light. As shown in FIG. 2C, the second light diffusing chamber may be configured to include an optical filter 52 configured to provide filtered light to the light source aperture. For example this may clip onto the proximal surface of the second chamber as shown in FIG. 2C. In some embodiments a plurality of filters may be used, and in use a plurality of images are collected each using a different filter. A slideable or rotatable filter plate could comprise multiple light filters, and be slid or rotated to allow alignment of a desired filter under the flash. In other embodiments the filter could be placed over the light aperture 43 or at the distal end of the lens arrangement 20. These may be manually moved or may be electronically driven, for example under control of the App.

As mentioned above a polarising filter may be located between the lens arrangement and the one or more objects, for example clipped or screwed onto the distal end of the lens arrangement. A polarising lens is useful for removing surface reflections from skin in medical applications, such as to capture and characterised skin lesions or moles, for example to detect possible skin cancers.

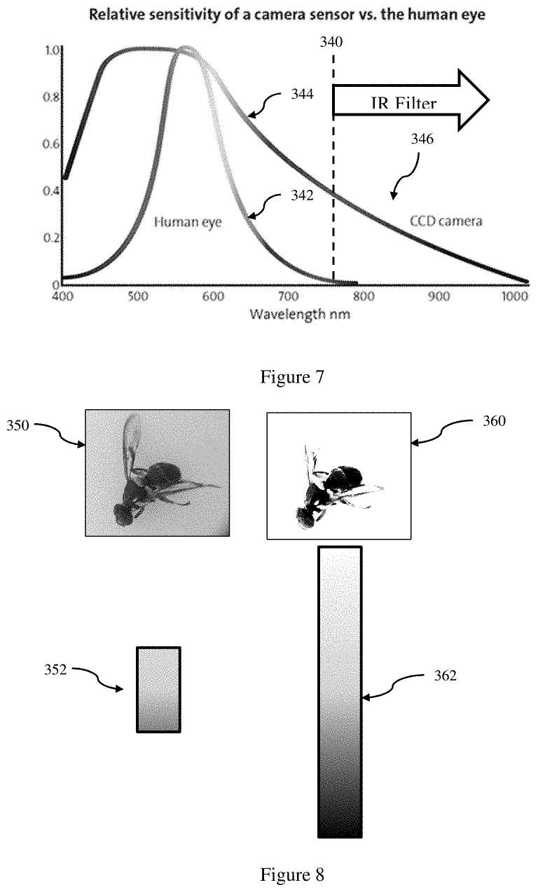

Many imaging sensors, such as CCD sensors have a wider wavelength sensitivity than the human eye. FIG. 7 shows a plot of the relative sensitivity of the human eye 342 and the relative sensitivity of a CCD image sensor 344 over the wavelength range from 400 to 1000 nm. As is shown in FIG. 7, the human eye is only sensitive to wavelength up to around 700 nm, whereas a CCD image sensor extends up to around 1000 nm. As CCD sensors are used for cameras in mobile computing devices they often incorporate an infrared filter 340 which is used to exclude infrared light 346 beyond the sensitivity of the human eye—typically beyond about 760 nm. Accordingly in some embodiments, the image sensor may be designed or selected to omit an Infrared filter, or any Infrared filter present may be removed. Similarly if a UV filter is present, this may be removed, or an image sensor selected that omits a UV-filter.

In some embodiments, one or more portions of the walls are semi-transparent. In one embodiment the floor portion may be transparent. This embodiment allows the mobile computing device with attached imaging apparatus to be inserted into a container of objects (e.g. seeds, apples, tea leaves) or where the apparatus is inverted with mobile computing device resting on a surface and the floor portion is used to support the objects to be imaged.

In one embodiment the app 310 is configured to collect a plurality of images each at different focal planes. The app 310 (or analysis module 327) is configured to combine the plurality of images into a single multi depth image, for example using Z-stacking. Many image libraries provide Z-stacking software allowing capturing of features across a range of depth of field. In another embodiment multiple images are collected, each of different parts of the one or more objects and the app 310 (or analysis module 327) is configured combine the plurality of images into a single stitched image. For example in this way an image of an entire leaf could be collected. This is useful when the magnification is high (and the field of view is narrow) or when the one or more objects are too large to fully fit within the chamber, or when the walls do not fully span the object. Different parts of the object can be captured in video or image made and then and then analysed using a system to combine the plurality of images into a single stitched image or other formats required for analysis. Additionally images captured from multiple angles can be used to reconstruct a 3 dimensional model of the object.

In some embodiments a video stream may be obtained, and one or more images from the video stream selected and used for training or classification. These may be manually selected or an object detector may be used (including a machine learning based object detector) which analyses each frame to determine if a target object is present in a frame (e.g. tea leaves, seed, insect) and if detected the frame is selected for training or analysis by the machine learning classifier. In some embodiments the object detector may also perform a quality check, for example to ensure the detected target is within a predefined size range.

In some embodiments app 310 (or analysis module 327) is configured to perform a colour measurement. This may be used to assess the image to ensure it is within an acceptable range or alternatively it may be provided to the classifier (for use in classifying the image)

In some embodiments, the app 310 (or analysis module 327) is configured to first capture an image without the one or more objects in the chamber, and then use the image to adjust the colour balance of an image with the one or more objects in the chamber. In some embodiments a transparent calibration sheet is located between the one or more objects and the optical assembly, or integrated within the optical assembly. Similarly one or more calibration inserts may be placed into the interior cavity and one or more calibration images captured. The calibration data can then be used to calibrate captured images for colour and/or depth. For example a 3D stepped object could be placed in the chamber, in which each step has a specific symbol which can be used to determine the depth of an object. In some embodiments the floor portion includes a measurement graticule. In another embodiment one or more reference or calibration object with known properties may be placed in the chamber with the object to be imaged. The known properties of the reference object may then be used during analysis to estimate properties of the target object, such as size, colour, mass, and may be used in quality assessment.

In some embodiments the wall structure 40 is an elastic material. In use the wall structure is deformed to vary the distance to the one or more objects from the optical assembly. A plurality of images may be collected at a range of distances to obtain different information on the object(s).

In some embodiments, the support surface 13 is an elastic object such as skin. In these embodiments a plurality of images may be collected, each at a range of pressure levels applied to the elastic object to obtain different information on the object.

In some embodiments, the app 310 (or analysis module 327) is configured to monitor or detect the lighting level within the chamber. This can be used as a quality control mechanism such that images may only be captured when the lighting level is within a predefined range.

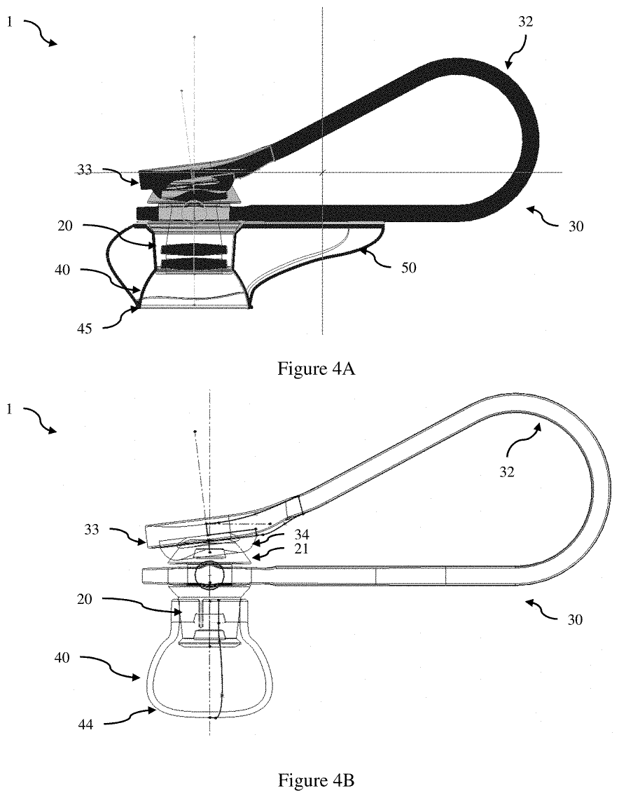

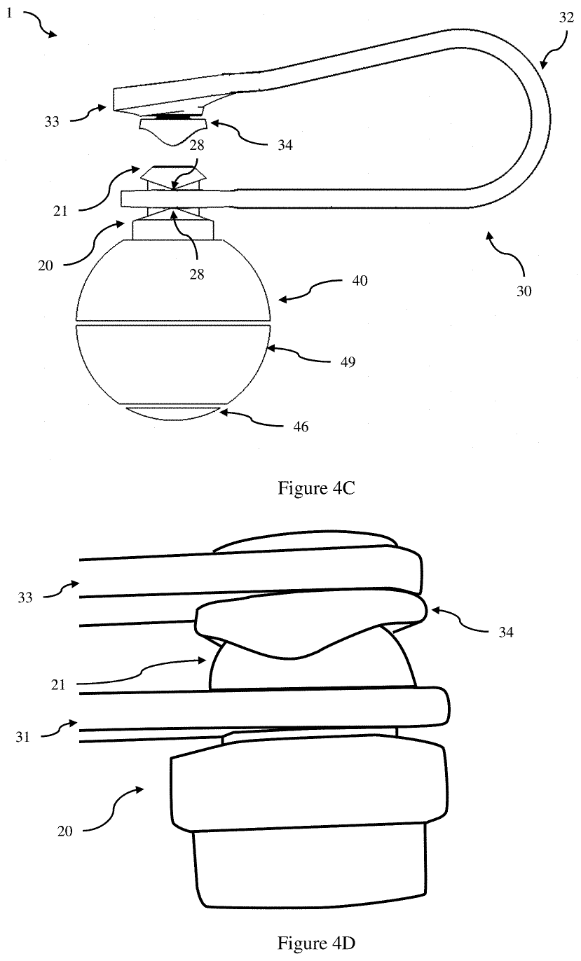

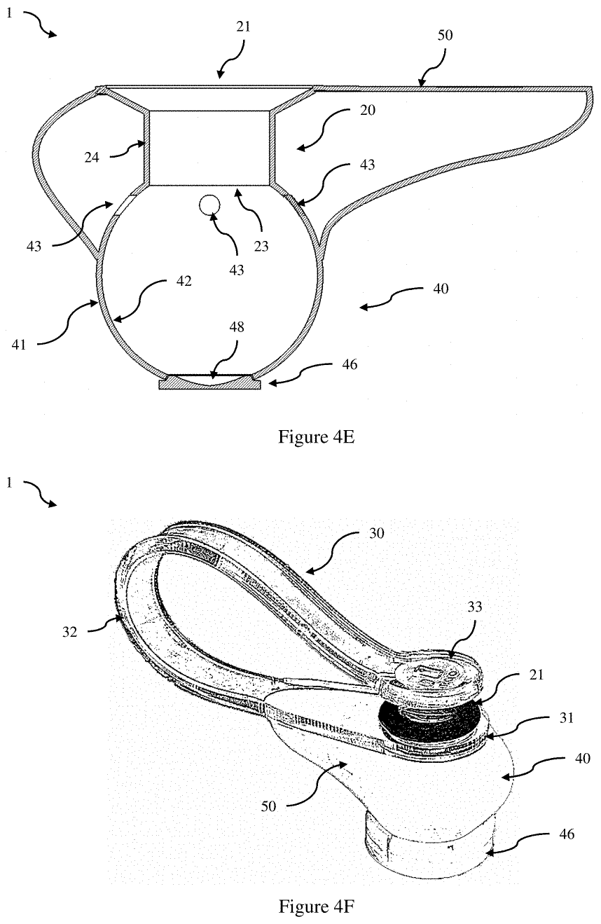

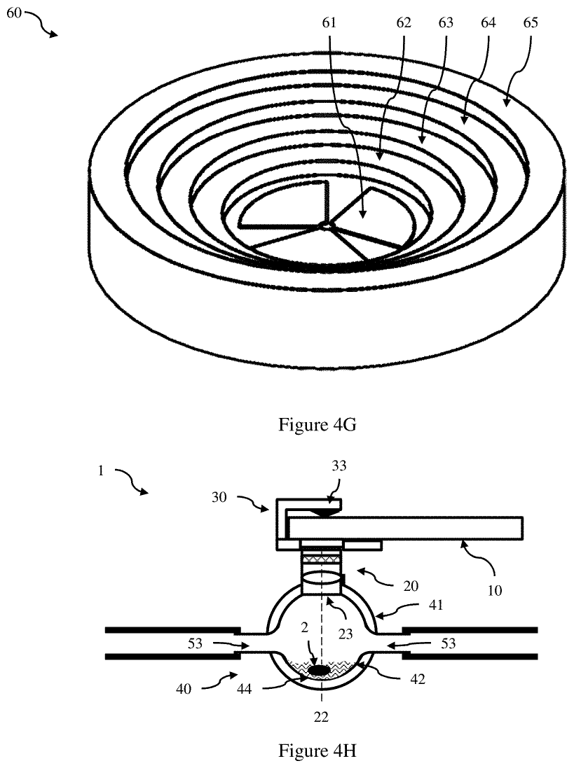

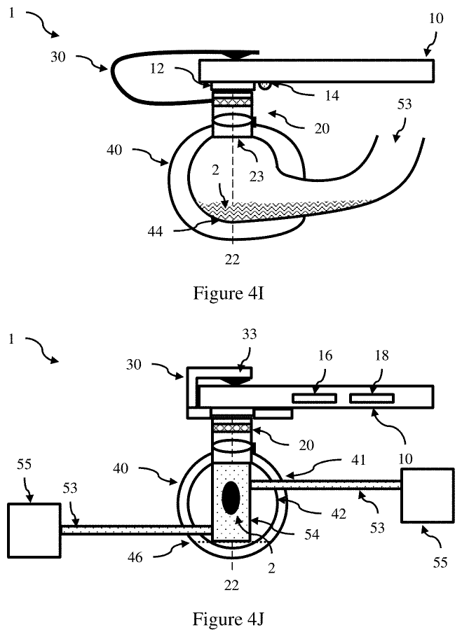

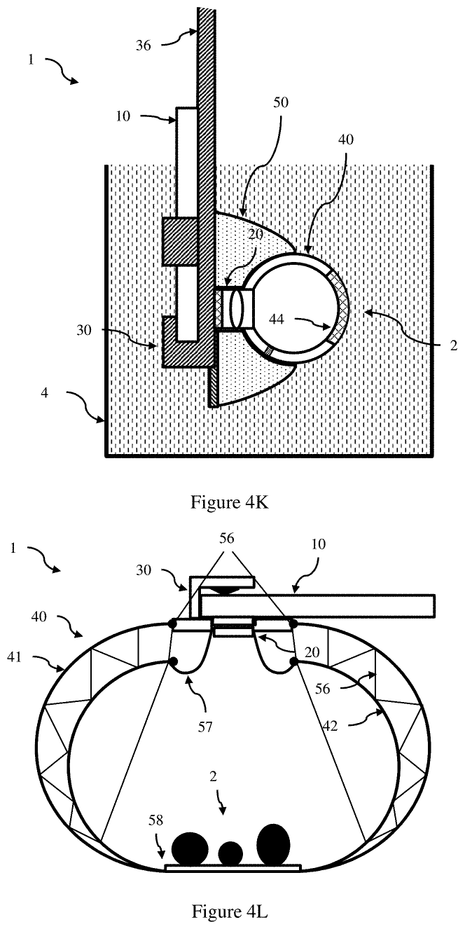

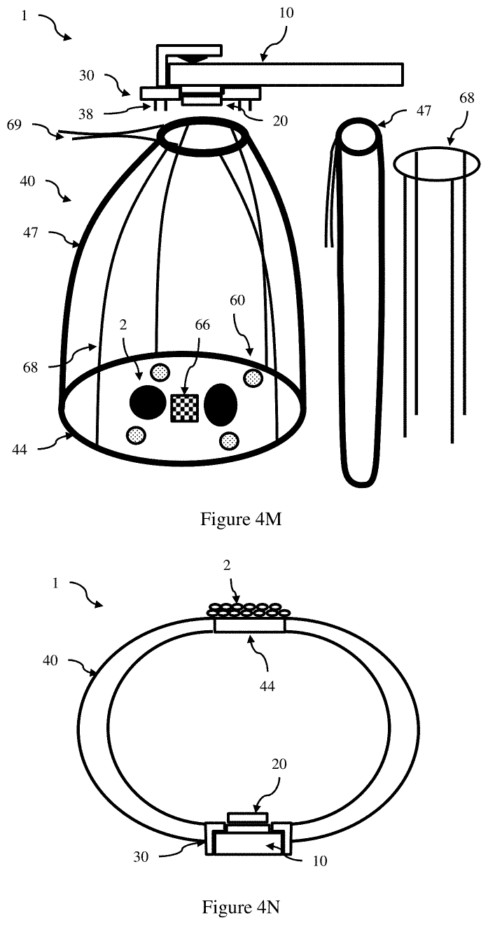

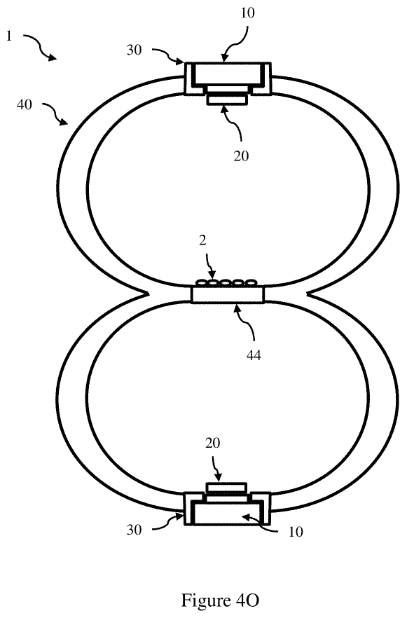

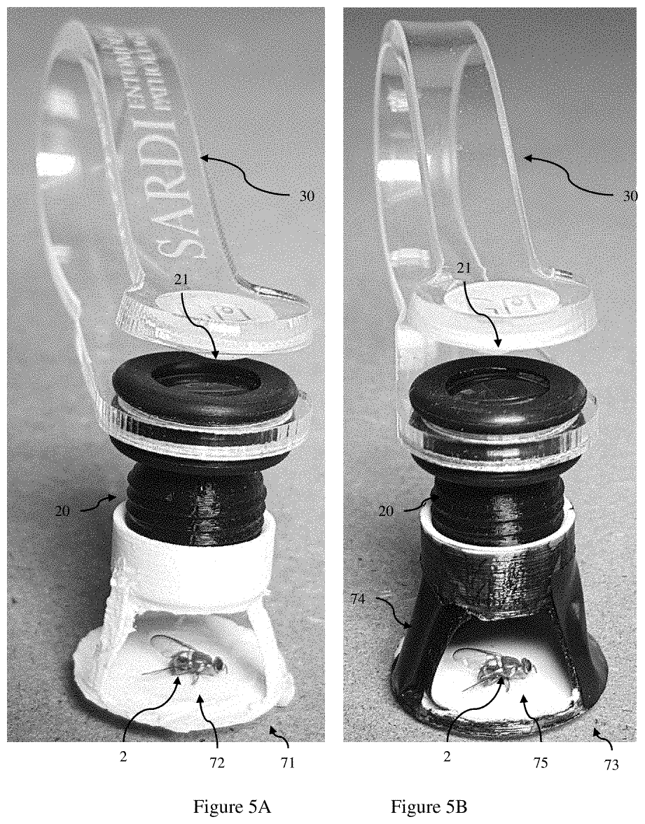

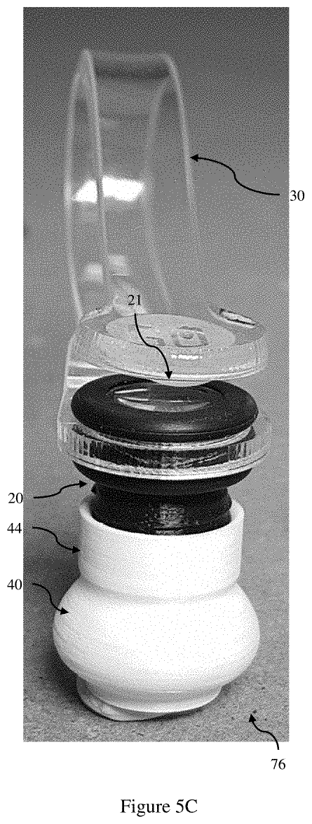

FIGS. 4A to 4M show various embodiments of imaging apparatus. These embodiments may be manufactured using 3D printing techniques, and it will be understood that the shapes and features may thus be varied. FIG. 4A shows an embodiment with a wall structure adapted to be placed over a support surface to form a chamber. A second diffusing chamber 50 provides diffused light from the flash to the walls 40. FIG. 4B shows another embodiment in which the sealed chamber 40 is an insect holder with a flattened floor. FIG. 4C shows another embodiment of a clipping arrangement in which the wall structure 40 is a spherical light integrator chamber with sections 49 and 46 to allow insertion of one or more objects into the chamber. In this embodiment the clip end 33 is a soft clamping pad 34 and can also serve as a lens cap over image sensor aperture 21 when not in use. The pad 34 has a curved profile so that the contact points will deliver a clamping force perpendicular to the optical assembly. The contact area is minimised to a line that is perpendicular to the clip. The optical assembly housing 24 comprises rocking points 28 to constrain the strap 32 to allow the optical axis to rock against the clip. FIG. 4A and 4 C show alternate embodiments of a rocking (or swing) arrangement. In FIG. 4A the rocking arrangement is extruded as part of the clip whilst in FIG. 4C the rocker is built into the runner portion 28. FIG. 4D is a close up view of the soft clamping pad 34 acting as a lens cap over image sensor aperture 21. FIG. 4E shows a cross sectional view of an embodiment of the wall structure 40 including a second diffusing chamber 50 and multiple light apertures 43. FIG. 4F shows a dual chamber embodiment comprising a chamber 40 with a spherical inner wall (hidden) and floor cap 46, with a second diffusing integrator chamber 50 which can capture light from a camera flash and diffuse it towards the first chamber 40. FIG. 4G is a perspective view of a calibration insert 60. The lower most central portion 61 comprises a centre piece with different coloured regions. This is surrounded by four concentric annular terrace walls, each having a top surface 62, 63, 64, and 65 of known height and diameter.

In some embodiments the chamber is slideable along in the optical axis 22 of the lens assembly to allow the depth to the one or more objects to be varied. In some embodiments the chamber may be made with a flexible material such as silicone which will allow a user to deform the walls to bring objects into focus. In another embodiment a horizontal component of light can be introduced into the chamber by adding serrations to the bottom edges of the chamber so that any top lighting can be directed horizontally. This can also be achieved by angling the surface of the chamber.

In one embodiment the chamber may be used to perform assessment of liquids or objects in liquids such as dish eggs in sea water. FIG. 4H is a side sectional view of an imaging apparatus for inline imaging of a liquid according to an embodiment. As shown in FIG. 4H, the wall structure 40 is modified to include two ports 53 which allow fluid to enter and leave the internal chamber. The two ports 53 may be configured as an inlet and an outlet port and may comprises valves to stop fluid flow or and may contain further ports to allow the chamber to be flushed. A transparent window may be provided over the image capture aperture 23. The wall structure may be constructed so as to act as a spherical diffuser. FIG. 4I is a side sectional view of an imaging apparatus for imaging a sample of a liquid according to an embodiment. In this embodiment, the port 53 is funnel which allows a sample of liquid to be poured into and enter the chamber. The funnel may be formed as part of the wall structure and manufactured of the same material to diffuse light entering the chamber. A cap (not shown) may be provided on the port opening 53 to prevent ingress of ambient light to the chamber.

FIG. 4J is a side sectional view of an imaging apparatus with an internal fluid chamber (e.g. transparent tube) 54 for suspending and three dimensional imaging of an object according to an embodiment. In this embodiment the tubular container is provided on the optical axis 22 and has an opening at the base, so that when the cap 46 is removed, an object can be placed in the internal tube 54. A liquid may be placed in the tube with the object to suspend the object, or one or more tubular connections 53 are connected to a liquid reservoir and associated pumps 55. In use the inner fluid chamber is filled with a liquid and the one or more objects to be imaged are suspended in the liquid in the inner fluid chamber 54. The one or more tubular connections can be used to fill the inner fluid chamber 54 and are also are configured to induce circulation within the inner fluid chamber. This circulation will cause a suspended object to rotate and thus enable capturing of images of the object from a plurality of different viewing angles, for example for three dimensional imaging.

FIG. 4K is a side sectional view of an imaging apparatus for immersion in a container of objects to be imaged according to an embodiment. In this embodiment the attachment apparatus further comprises an extended handle (or tube) 36 and the distal portion 44 is a transparent window. This enables at least the wall structure 40 and potentially the entire apparatus and smartphone to be immersed in a container 4 of objects such as tea, rice, grains, produce, etc. In some embodiments the transparent window 44 is a fish eye lens. A video may be captured of the immersion, and then be separated into distinct images, one or more of which may be separately classified (or used for training). The apparatus may be immersed to a depth such that the surrounding objects block or mitigate external light from entering the chamber via the transparent window 44.

FIG. 4L is a side sectional view of a foldable imaging apparatus for imaging of large objects according to an embodiment. In this embodiment the wall structure 40 is a foldable wall structure comprising an outer wall 41 comprises of a plurality of pivoting ribs covered in a flexible material. The inner surface 42 is also made of a flexible material and one or more link members 56 connect the flexible material to the outer wall structure. When in the unfolded configuration the one or more link members are configured to space the inner surface from the outer wall structure and one or more tensioning link members pull the inner surface into a curved profile such as spherical configuration or near spherical configuration. The link members may be thus be a cable 56 following a zig zag path between the inner surface 42 and outer wall 41 so that tension can be applied to a free end of the cable to force the inner surface to adopt a spherical configuration. Light baffles 57 may also be provided to separate the outer wall 41 and the inner surface 42. The floor portion 44 may be a base plate and may be rotatable. The attachment arrangement may be configured as a support surface for supporting and holding mobile phone in position. This embodiment may be used to image large objects.

FIG. 4M is a perspective view of an imaging apparatus in which the wall structure is a bag 47 with a flexible frame 68 for assessing quality of produce according to an embodiment. In this embodiment the wall structure 40 is a translucent bag 47 and the apparatus further comprises a frame structure 68 comprised of ring structure located around the image capture aperture 23 and a plurality of flexible legs. In use they can be configured to adopt a curved configuration to force the wall of the translucent bag to adopt a curved profile. The attachment apparatus 30 may comprises clips 34 for attaching to the top of the bag, and a drawstring 68 may be used to tighten the bag on the stand. The distal or floor portion 44 of the translucent bag may comprise or supports a barcode identifier 66 and one or more calibration inserts 60 for calibrating colour and/or size (dimensions). This embodiment enables farmers to assessing quality of their produce at the farm or point of sale. For example the smartphone may execute a classifier may be trained to classify objects (produce) according to a predefined quality assessment classification system. For example a farmer could assess the quality of their produce prior to sale by placing multiple images in the bag. The classifier could identify if particular items failed a quality assessment and be removed. In some embodiment the system may be further configured to assess a weight and a colour of an object to perform a quality assessment on the one or more objects. This allows famers including small scale farmers to assess and sell their produce. The bag can be used to perform the quality assessment and the weight can be estimated or the bag weighed. Alternatively the classification results can be provided with the produce when shipped.

FIG. 4L is a side sectional view of a foldable imaging apparatus configured as a table top scanner according to an embodiment In this embodiment the distal portion 44 is transparent and the attachment arrangement is configured to hold the mobile phone in place, and the distal portion supports the objects to be imaged. A cap may be placed over objects 2 or sufficient objects may be placed on the distal portion 44 to prevent ingress of light into the chamber 40. FIG. 4M is a side sectional view of a foldable imaging apparatus configured as a top and bottom scanner according to an embodiment. This requires two mobile computing apparatus to capture images of the both sides of the objects.

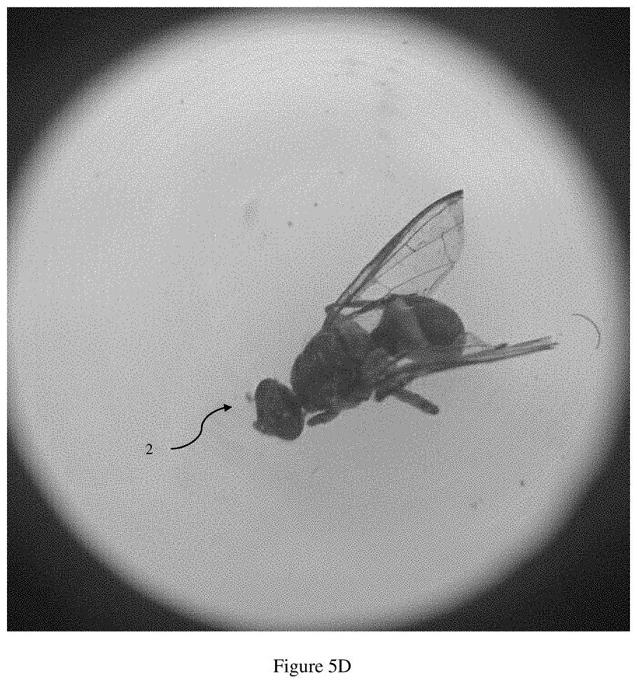

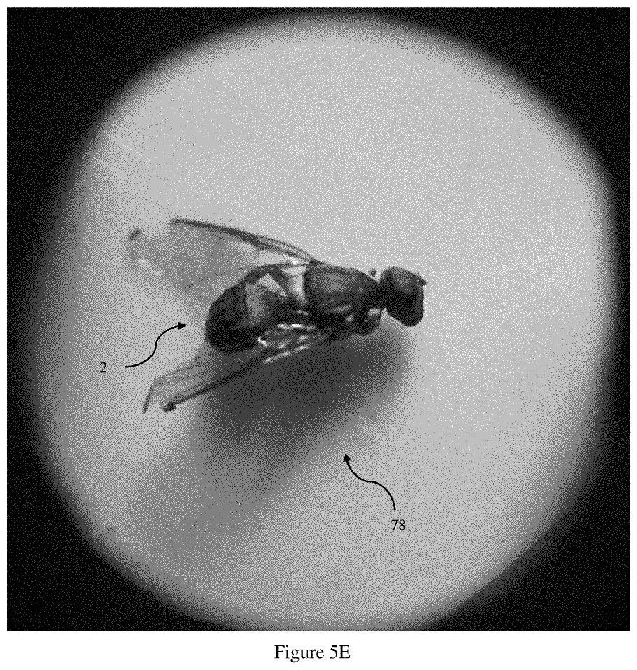

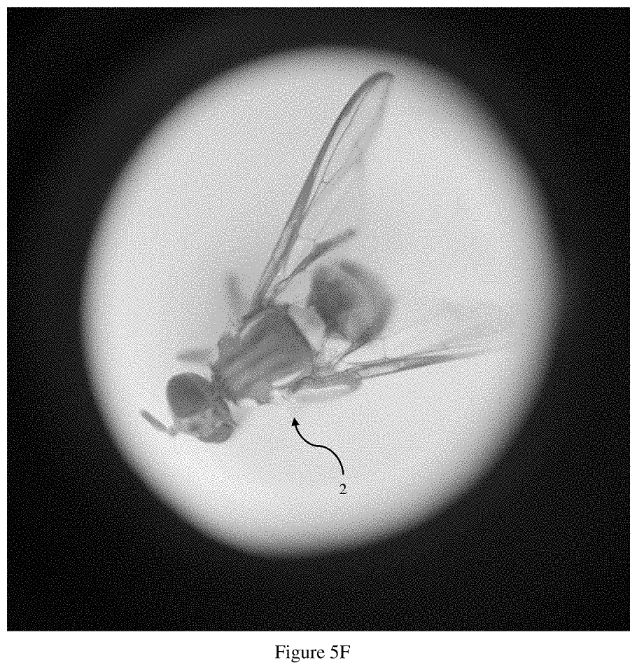

Table 1 shows the results of a lighting test, in which an open source machine learning model (or AI engine) was trained on a set of images, and then used to classify objects under 3 different lighting conditions in order to assess the effect of lighting on machine learning performance. The machine learning (or AI engine) was not tuned to maximize detection as the purpose here was to assess the relative differences in accuracy using the same engine but different lighting conditions. Tests were performed on a dataset comprising 2 classes of objects, namely junk flies and Queensland Fruit Flies (QFFs), and a dataset comprising 3 classes of objects, namely junk flies, male QFF and female QFF. FIG. 5A shows the natural lighting test environment 71 in which an object was placed on white open background support 72 and an image 19 captured by a smart phone 10 using a clip-on optical assembly 30 under natural window lighting (Natural Lighting in Table 1). FIG. 5B shows the shadow lighting test environment 73 in which a covered holder 74 includes a cut out portion 75 to allow light from one side to enter in order to cast shadows from directed window lighting (Shadow in Table 1). FIG. 5C shows the chamber lighting test environment 76 in which the object was placed inside chamber 40, and the chamber secured to the optical assembly using a screw thread arrangement 44 to create a sealed chamber. Light from the camera flash 18 as directed into the chamber to create diffuse uniform light within the chamber. FIGS. 5D, 5E and 5F show examples of captured images under the natural lighting, shadow lighting and chamber lighting conditions. The presence of shadows 78 can be seen in the shadow lighting image. The chamber image shows a bright image with no shadows.

TABLE 1
Lighting test results showing the relative performance of an open source
machine learning classifier model on detection for 3 different lighting
conditions.

| Test | Classes | Test 1 | Test 2 | Test 3 | Average |
|---|---|---|---|---|---|
| Natural Light | 2 | 84% | 77% | 84% | 82% |
| | 3 | 71% | 61% | 65% | 66% |
| Shadow | 2 | 73% | 72% | 86% | 78% |
| | 3 | 63% | 67% | 60% | 63% |
| Chamber | 2 | 100% | 97% | 94% | 97% |
| | 3 | 84% | 94% | 94% | 91% |

Table 1 illustrates the significant improvement of AI system provided by using a chamber configured to eliminate shadows and create uniform diffuse lighting of the one or more objects to be imaged. The shadow results were performed slightly worse than the Natural lighting results, and both the natural lighting and shadow results were significantly less accurate than the chamber results.

As discussed the wall structure 40 (including diffusing chamber 50) is configured to create both uniform lighting conditions and uniform background lighting on the object(s) being imaged. This thus reduces the variability in lighting conditions of images captured for training the machine learning classifier. Without being bound by theory it is believed this approach is successful, at least in part, due to effectively reducing the dynamic range of the image. That is the by controlling the lighting and reducing shadows the absolute range of intensities values is smaller than if the image was exposed to natural light or direct light from a flash. Most image sensors, such as CCDs are configured to automatically adjust image capture parameters to the avoid oversaturation of the image sensor. In most digital image sensors a fixed number of bits (and thus discrete values) are used to capture and digitise the intensity data. Thus if there are very bright and very dim intensities present the dynamic range of intensities is large and so the range of each value (intensity bin) is large compared to the case with a smaller dynamic range. This is illustrated in FIG. 8 which shows a first image 350 of a fly captured using an embodiment of the apparatus described herein in to generate uniform lighting conditions and reduces shadows and a second image 360 captured under normal lighting conditions. The dynamic range of intensities for the first image 352 is much smaller than they dynamic range of intensities for the second image 362 which must cover very bright and very dim/dark values. If the same number of bits are used to digitise each dynamic range 352 362 then it is clear that the range of intensity values spanned by each digital value (i.e. range per bin) is smaller for the first image 350 than the second. It is hypothesises that this effectively increases the amount of information captured on the image, or at least enables detection of finer spatial detail which can be used in training the machine learning classifier. This control of lighting to reduce the variability in the lighting conditions has a positive effect on training of the machine learning classifier, as it results in faster and more accurate training. This also means that fewer images are required to train the machine learning classifier.

What is more surprising is that when the trained machine learning classifier is deployed for classification of new images, the classifier retains its accuracy even if images are captured in natural lighting without the use of imaging attachment 1 (i.e. the lighting chamber). Table 2 illustrates the performance of a trained machine learning classifier on images taken with an embodiment of an imaging attachment attached to a mobile phone, and on images taken without an embodiment of an imaging attachment attached to a mobile phone (i.e. natural lighting). The machine learning classifier was trained on images captured using an embodiment of an imaging attachment attached to a mobile phone (i.e. uniform lighting conditions). The training was performed using tensor flow with 50 epochs of training, a batch size of 16 and a learning rate of 0.001 on 40 images of random flies and 40 images of Queensland fruit flies (QFF). The results show the test results for 9 images which were not used in training, and the result in the table is the probability (out of 100) assigned by the trained machine learning classifier upon detection.

TABLE 2
Test results showing the relative performance of a trained machine
learning classifier used to classify images with and without an embodiment
of the imaging apparatus attached to a mobile phone.

| | Image taken with | | Image taken without imaging | |
|---|---|---|---|---|
| | imaging apparatus attached | | apparatus attached to mobile | |
| | to mobile phone | | phone (natural lighting) | |
| | Random Fly | QFF | Random Fly | QFF |
| | 86 | 100 | 97 | 100 |
| | 97 | 51 | 91 | 96 |
| | 100 | 81 | 72 | 100 |
| | 100 | 92 | 96 | 99 |
| | 96 | 99 | 28 | 99 |
| | 100 | 100 | 44 | 100 |
| | 100 | 100 | 93 | 99 |
| | 100 | 100 | 100 | 7 |
| | 100 | 63 | 68 | 100 |
| Average | 98 | 87 | 77 | 89 |

It can thus be seen that highly accurate results are still achieved on images collected without the imaging attachment attached to a mobile phone (natural lighting conditions). Whilst best results are obtained if the images to be classified are captured using an embodiment of imaging apparatus 1 as described herein (the same or similar to the apparatus used to train the classifier), the results obtained on classifying images captured just using the image sensor of a mobile computing device are still highly accurate. This enables more wide spread use of the classifier as it can be used by users who do not have the imaging apparatus (lighting chamber), or in the field where it may not be possible to place the object in the lighting chamber.

Testing as has shown that the system can be accurately trained on as little as 40 to 50 images, illustrating that the high quality (or clean) images enables the classifier to quickly identify relevant features. However many more images may be used to train the classifier if desired.

Embodiments described herein provide improved systems and methods for capturing and classifying images collected in the test and field environments. Current methods are focused on microscopic photographic techniques and generating compact devices whereas this system focusses on the use of chamber to control lighting and thus generate clean images (i.e. uniform lighting and background with a small dynamic range) for training a machine learning classifier. This speeds up the training and generates a more robust classifier which performs well on dirty images collected in natural lighting. Embodiments of a system and method for classifying an image captured using a mobile computing apparatus such as a smartphone with an attachment arrangement such as clip on magnification arrangement are described. Embodiments are designed to create a chamber which provides uniform lighting to the one or more objects based on light integrator principles and eliminates the presence of shadows, and reduces the dynamic range of image compared to images taken in natural lighting or using flashes. Light integrators (and similar shapes) are able to create uniform lighting by virtue multiple internal reflections and are substantially spherical in shape causing the intensity of light reaching the one or more objects to be similar in all directions. By creating uniform lighting conditions the method and system greatly reduce the number of images required for training the machine learning model (or AI engine) and increases the accuracy of detection by greatly, by reducing the variability in imaging. For example if an image of a 3D object is obtained with 10 distinctively different lighting conditions and 10 distinctively different backgrounds then the parameter space or complexity of images increases by a hundred fold. Embodiments of the apparatus described herein are designed to eliminate both these variations allowing it to have a hundred fold improvement in accuracy of detection. It can be deployed with a low cost clip on (or similar) device attachable to mobile phones utilizing ambient lighting or the camera flash for lighting. Light monitoring can also be performed by the camera. By doing the training and assessment under the same lighting conditions significant improvements in accuracy is achieved. For example an accurate and robust system can be trained with as little as 50 images, and will work reliably on laboratory and field captured images. Further the classifier still works accurately if used on images taken in natural lighting (i.e. not located in the chamber). A range of different embodiments can be implemented based around the chamber providing uniform lighting and eliminating shadows. An application executing on either the phone or in the cloud may combine and processes multiple adjacent images, multi depth images, multi spectral and polarized images. The low cost nature of the apparatus and the ability to work with any phone or tablet makes it possible to use the same apparatus for obtaining the training images and images for classification enabling rapid deployment and wide spread use including for small scale and subsistence farmers. The system can be also be used for quality assessment.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art.

Further, it should be appreciated that modules and/or other appropriate means for performing the methods and techniques described herein can be downloaded and/or otherwise obtained by a computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can be utilized.

In one form the invention may comprise a computer program product for performing the method or operations presented herein. For example, such a computer program product may comprise a computer (or processor) readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the term “analysing” encompasses a wide variety of actions. For example, “analysing” may include calculating, computing, processing, deriving, investigating, looking up (e.g., looking up in a table, a database or another data structure), ascertaining and the like. Also, “analysing” may include receiving (e.g., receiving information), accessing (e.g., accessing data in a memory) and the like. Also, “analysing” may include resolving, selecting, choosing, establishing and the like.

1. An imaging apparatus configured to be attached to a mobile computing apparatus comprising an image sensor the imaging apparatus comprising:
an optical assembly comprising a housing with an image sensor aperture, an image capture aperture and an internal optical path linking the image sensor aperture to the image capture aperture within the housing;
an attachment arrangement configured to support the optical assembly and allow attachment of the imaging apparatus to a mobile computing apparatus comprising an image sensor such that the image sensor aperture of the optical assembly can be placed over the image sensor;
a wall structure extending distally from the optical assembly and comprising an inner surface connected to and extending distally from the image capture aperture of the optical assembly to define an inner cavity, wherein the wall structure is either a chamber that defines the internal cavity and comprises a distal portion which, in use, either supports one or more objects to be imaged or the distal portion is a transparent window which is immersed in and placed against one or more objects to be imaged, or a distal end of the wall structure forms a distal aperture such that, in use, the distal end of the wall structure is placed against a support surface supporting or incorporating one or more objects to be imaged so as to form a chamber, and the inner surface of the wall structure is reflective apart from at least one portion comprising a light source aperture configured to allow light to enter the chamber and the inner surface of the wall structure has a curved profile to create uniform lighting conditions on the one or more objects being imaged and uniform background lighting;
wherein, in use, the mobile computing apparatus with the imaging apparatus attached is used to capture and provide one or more images to a machine learning based classification system, wherein the one or more images are either used to train the machine learning based classification system or the machine learning system was trained on images of objects captured using the same or an equivalent imaging apparatus and is used to obtain a classification of the one or more images.

2. The imaging apparatus as claimed in claim 1, wherein the optical assembly further comprises a lens arrangement having a magnification of between up to 400 times.

3. The imaging apparatus as claimed in claim 1, wherein the curved profile is a spherical profile.

4. The imaging apparatus as claimed in claim 3, wherein the inner surface acts as a Lambertian reflector and the chamber is configured to act as a light integrator to create uniform lighting within the chamber and to provide uniform background lighting.

5. The imaging apparatus as claimed in claim 1, wherein the curved profile of the inner surface is configured to uniformly illuminate a 3-Dimensional object within the chamber to minimise or eliminate the formation of shadows.

6. The imaging apparatus as claimed in claim 1, wherein the wall structure and/or light source aperture is configured to provide diffuse light into the internal cavity.

7. The imaging apparatus as claimed in claim 1, further comprising one or more filters configured to provide filtered light to the light source aperture and/or a multi-spectral light source configured to provide light in one of a plurality of predefined wavelength bands to the light source aperture.

8. The imaging apparatus as claimed in claim 1, wherein the wall structure is an elastic material and in use, the wall structure is deformed to vary the distance to the one or more objects from the optical assembly and a plurality of images are collected at a range of distances.

9. The imaging apparatus as claimed in claim 1, wherein the chamber further comprises an inner fluid chamber with transparent walls aligned on an optical axis and one or more tubular connections are connected to a liquid reservoir such that in use, the inner fluid chamber is filled with a liquid and the one or more objects to be imaged are suspended in the liquid in the inner fluid chamber, and the one or more tubular connections are configured to induce circulation within the inner fluid chamber to enable capturing of images of the object from a plurality of different viewing angles.

10. The imaging apparatus as claimed in claim 1, wherein wall structure is a foldable wall structure comprising an outer wall structure comprises of a plurality of pivoting ribs, and the inner surface is a flexible material and one or more link members connect the flexible material to the outer wall structure such that when in an unfolded configuration the one or more link members are configured to space the inner surface from the outer wall structure and one or more tensioning link members pull the inner surface to adopt the curved profile.

11. The imaging apparatus as claimed in claim 1, wherein the wall structure is a translucent bag and the apparatus further comprises a frame structure comprised of ring structure located around the image capture aperture and a plurality of flexible legs which in use can be configured to adopt a curved configuration to force the wall of the translucent bag to adopt the curved profile.

12. The imaging apparatus as claimed in claim 1, wherein the attachment arrangement is a removable attachment arrangement.

13. A machine learning based imaging system comprising:
an imaging apparatus according to claim 1; and
a machine learning based analysis system comprising at least one processor and at least one memory, the memory comprising instructions to cause the at least one processor to provide an image captured by the imaging apparatus to a machine learning based classifier, wherein the machine learning based classifier was trained on images of objects captured using the imaging apparatus, and obtaining a classification of the image.

14. The machine learning based imaging system as claimed in claim 13 further comprising a mobile computing apparatus to which the imaging apparatus is attached.

15. The machine learning based imaging system as claimed in claim 14 wherein the mobile computing apparatus comprises an image sensor without an Infrared filter or UV filter.

16. The machine learning based imaging system as claimed in claim 13 wherein the machine learning classifier is configured to classify an object according to a predefined quality assessment classification system.

17. The machine learning based imaging system as claimed in claim 16 wherein the system is further configured to assess one or more geometrical, textual and/or colour features of an object to perform a quality assessment on the one or more objects.

18. A method for training a machine learning classifier to classify an image captured using an image sensor of a mobile computing apparatus, the method comprising:
attaching an attachment apparatus of an imaging apparatus to a mobile computing apparatus such that an image sensor aperture of an optical assembly of the attachment apparatus is located over an image sensor of the mobile computing apparatus, wherein the imaging apparatus comprises an optical assembly comprising a housing with the image sensor aperture, and an image capture aperture and an internal optical path linking the image sensor aperture to the image capture aperture within the housing and a wall structure with an inner surface, wherein the wall structure either defines a chamber wherein the inner surface defines an internal cavity and comprises a distal portion for either supporting one or more objects to be imaged or a transparent window or a distal end of the wall structure forms a distal aperture and the inner surface is reflective apart from a portion comprising a light source aperture configured to allow light to enter the chamber and has a curved profile to create uniform lighting conditions on the one or more objects being imaged and uniform background lighting;
placing one or more objects to be imaged in the chamber such that they are supported by the distal portion, or immersing at least the distal portion of the chamber into a plurality of objects such that one or more objects are located against the transparent window, or placing the distal end of the wall structure against a support surface supporting or incorporating one or more objects to be imaged so as to form a chamber;
capturing a plurality of images of the one or more objects;
providing the one or more images to a machine learning based classification system and training the machine learning system to classify the one or more objects, wherein in use the machine learning system is used to classify an image captured by the mobile computing apparatus.

19. The method as claimed in claim 18, wherein the optical assembly further comprises a lens arrangement having a magnification of up to 400 times.

20. The method as claimed in claim 18, wherein the curved profile is a near spherical profile.

21. The method as claimed in claim 20, wherein the inner surface acts as a Lambertian reflector and the chamber is configured to act as a light integrator to create uniform lighting within the chamber and to provide uniform background lighting.

22. The method as claimed in claim 18 wherein the wall structure and/or light source aperture is configured to provide diffuse light into the internal cavity.

23. The method as claimed in claim 18, wherein the imaging apparatus further comprises one or more filters configured to provide filtered light to the light source aperture and/or a multi-spectral light source configure to provide light in one of a plurality of predefined wavelength bands to the light source aperture.

24. The method as claimed in claim 18, wherein the wall structure is an elastic material and the method further comprises capturing a plurality of images, wherein between images the wall structure is deformed to vary the distance to the one or more objects from the optical assembly so that the plurality of images are captured at a range of distances.

25. The method as claimed in claim 18 wherein the images are captured by a modified mobile computing apparatus comprising an image sensor without an Infrared Filter or a UV filter.

26. The method as claimed in claim 18 wherein the machine learning classification system classifies an object according to a predefined quality assessment classification system.

27. The method as claimed in claim 18 wherein the attachment apparatus comprises an inner fluid chamber with transparent walls aligned on an optical axis and one or more tubular connections are connected to a liquid reservoir and the method comprises filling the inner liquid chamber with a liquid and suspending one or more objects to be imaged in the inner liquid chamber, and capturing a plurality of images wherein between images the one or more tubular connections are configured to induce circulation within the inner chamber to adjust the orientation of the one or more objects.

28. The method as claimed in claim 18 wherein the wall structure is a foldable wall structure comprising an outer wall structure comprises of a plurality of pivoting ribs, and the inner surface is a flexible material and one or more link members connect the flexible material to the outer wall structure and the method further comprises unfolding the wall structure into an unfolded configuration such that the one or more link members space the inner surface from the outer wall structure and one or more tensioning link members pull the inner surface to force the inner surface to adopt the curved profile.

29. The method as claimed in claim 18 wherein the wall structure is a translucent bag and a frame structure with a ring structure and a plurality of flexible legs, and the method further comprises curving the plurality of flexible legs to adopt a curved configuration to force the wall of the translucent bag to adopt the curved profile.

30. A method for classifying an image captured using an image sensor of a mobile computing apparatus, the method comprising:
capturing one or more images of the one or more objects using the mobile computing apparatus;
providing the one or more images to a machine learning based classification system to classify the one or more images, wherein the machine learning based classification system is trained according to the method of claim 18.

31. The method as claimed in claim 30 wherein capturing one or more images comprises:
attaching an attachment apparatus to a mobile computing apparatus such that an image sensor aperture of an optical assembly of the attachment apparatus is located over an image sensor of the mobile computing apparatus, wherein the imaging apparatus comprises an optical assembly comprising a housing with the image sensor aperture, and an image capture aperture and an internal optical path linking the image sensor aperture to the image capture aperture within the housing and a wall structure with an inner surface, wherein the wall structure either defines a chamber wherein the inner surface defines an internal cavity or a distal portion of the wall structure forms a distal aperture and the inner surface is reflective apart from a portion comprising a light source aperture configured to allow light to enter the chamber and has a curved profile to create uniform lighting conditions on the one or more objects being imaged and uniform background lighting;
placing one or more objects to be imaged in the chamber, or immersing a distal portion of the chamber in one or more objects, or placing the distal end of the wall structure against a support surface supporting or incorporating one or more objects to be imaged so as to form a chamber; and
capturing one or more images of the one or more objects.

32. A machine learning computer program product comprising computer readable instructions, the instructions causing a processor to:
receive a plurality of images captured using an imaging sensor of a mobile computing apparatus to which an imaging apparatus of claim 1 is attached;
train a machine learning classifier on the received plurality of images.

33. A machine learning computer program product comprising computer readable instructions, the instructions causing a processor to:
receive one or more images captured using an imaging sensor of a mobile computing apparatus;
classify the received one or more images using a machine learning classifier trained on images of objects captured using an imaging apparatus of claim 1 attached to an imaging sensor of a mobile computing apparatus.
